(19) United States
(12) Patent Application Publication
(10) Pub. No.: US 2010/0217568 A1
(43) Pub. Date: Aug. 26, 2010

(54) VARIATION SIMULATION SYSTEM, METHOD FOR DETERMINING VARIATIONS, APPARATUS FOR DETERMINING VARIATIONS AND PROGRAM

(75) Inventor: Kiyoshi Takeuchi, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 12/278,884

(22) PCT Filed: Nov. 16, 2006
(86) PCT No.: PCT/JP2006/322839

§ 371 Date: Aug. 8, 2008

(30) Foreign Application Priority Data
Feb. 8, 2006 (JP) 2006-031441

(51) Int. Cl. G06F 17/11; G06F 17/16; G06F 17/50

(52) U.S. Cl. 703/2

(57) ABSTRACT

Disclosed is a variation simulation system including a variation analysis unit that acquires the results of statistical analysis of variations of characteristics of a plural number of target devices, a model analysis unit that acquires the results of analysis showing how the characteristics respond to variations of a parameter with respect to a model for simulation that simulates each target device, a fitting execution unit that collates the results obtained by the variation analysis unit to those obtained by the model analysis unit and determines the manner of variations of the parameter in order to reproduce the variations of each target device in accordance with the model, and a result output unit that outputs the information on the manner of variations of the parameter determined by the fitting execution unit. A transformation matrix is determined by multiplying a pseudo inverse matrix of a response matrix, a matrix made up of principal component vectors and an arbitrary unitary matrix.

### TECHNICAL FIELD

This invention relates to a system, a method and a program for simulation of variations. More particularly, this invention relates to a system, a method and a program for simulation of variations that may be used to advantage to efficiently simulate variations in characteristics in electronic circuits.

### BACKGROUND ART

In designing a circuit employing electronic devices, such as a CMOS circuit, circuit simulation is extensively used. In the circuit simulation, the characteristics of the electronic device, such as current-to-voltage characteristic or capacitance-to-voltage characteristic, are described by mathematical equations (model equation usually made up of a plurality of expressions). These mathematical equations include a set of quantities termed parameters. In carrying out the circuit simulation, it is necessary to determine the values of these model parameters so that the model equation will approximately accurately reproduce actual device characteristics. This operation is termed ‘parameter extraction’. A set of the so determined parameters, or a model of a particular device, specified by these parameters, is herein termed a ‘device model’ or simply as ‘a model’. The manner of expressing device characteristics, as determined by the model equation, is termed a ‘model basis’, in distinction from the model of a specific model.

In the characteristics of electronic devices, there exist variations or ‘uncertainties’ of characteristics ascribable to fabrication variations. Hence, the circuit designing must be so made that the circuit will operate normally even though device characteristics are varied to some extent.

T cope with this problem, it is customary, in designing large-scale logic circuits, to deal with the device-based variations as follows: That is, a ‘corner model’ having its characteristic deviated to the maximum conceivable extent is provided in addition to an average device model. For example, a device having its driving capability varied to a maximum value and another device having its driving capability varied to a minimum value are presupposed. The former has a high operating speed, while the latter has a low operating speed. A high-speed model and a low-speed model are provided for the two devices, respectively. The circuit is designed with a sufficient margin so that the circuit will operate no matter which of these two devices is used. A circuit may thus be constructed which will operate in stably despite variations in device characteristics.

Although the method by the corner models, described above, is a simple method for dealing with variations, the technique that takes the effects which the variations have on the circuit into account more precisely is disclosed in, for example, Non-Patent Documents 1 and 2. Initially, N number of devices (samples), the characteristics of which differ due to variations, are provided, and characteristics thereof are measured.

In particular, in Non-Patent Document 1, N number of devices are generated by device simulation which takes the phenomena of variations into account. Measurement is simulated by a computer.

Parameter extraction is carried out for each of the devices to produce N number of device models.

Finally, circuit simulation is carried out for the N number of devices to check how the circuit characteristics are varied.

Or, as described in Non-Patent Document 2, the parameters of the N number of device models may be processed statistically to check how the model parameters are varied, and a statistical simulation may then be carried out on the basis of the so derived information.

### Non-Patent Document 1:

B. J. Cheng et al., “Integrating ‘atomistic’, intrinsic parameter fluctuations into compact model circuit analysis”, 33rd Conference on European Solid-State Device Research (ESSDERC 2003), extended abstracts, Sep. 16, 2003, pp. 437-440

### Non-Patent Document 2:

J. Carroll et al., “FET Statistical Modeling Using Parameter Orthogonalization”, IEEE Transactions on Microwave Theory and Techniques, Vol. 44, 1996, pp. 47-55

### DISCLOSURE OF THE INVENTION

### Problems to be Solved by the Invention

The conventional techniques, disclosed in the above-mentioned Non-Patent Documents 1 and 2, suffer from the following problems:

With the methods disclosed in Non-Patent Documents 1 and 2, it is aimed to conduct simulation which takes variations into account more precisely than with the use of the corner models. As a preparative process, a device model is produced for each of N number of devices differing in characteristics from one another due to variations.

The parameter extraction operation carried out in order to decide a device model involves usually a fitting operation by a trial-and-error method, which is a labor-consuming operation. Repetition of labor-consuming parameter extracting operations a large number of times means a severe load thus becoming an obstacle against implementing the simulation which takes variations into account in detail.

It is an object of the present invention to provide a system, a method and a program for simulation of variations in which simulation that takes variations into account in detail may be carried out efficiently.

In the present invention, there is provided a variation simulation system which determines the manner of variations of a preset parameter based on response information of a characteristic value simulated by a model, to a preset parameter, in such a manner that a statistical property of the characteristic value which reflects a physical phenomenon will be reproduced by the model which simulates the physical phenomenon.

In the present invention, there is provided an apparatus that determines a variation model according to the present invention comprises:

means for extracting a statistical property of a characteristic value which reflects a physical phenomenon;

means for acquiring response information to a preset parameter of the characteristic value simulated by a model which simulates the physical phenomenon; and

means for determining the manner of variations of the preset parameter, based on the response information, so that the statistical property will be reproduced by the model.

In the present invention, there is provided a method for determining a variation model, using a computer system, in which the method comprises:

a first step of extracting a statistical property of a characteristic value which reflects a physical phenomenon;

a second step of acquiring response information to a preset parameter of the characteristic value simulated by a model which simulates the physical phenomenon; and

a third step of determining the manner of variations of the preset parameter, based on the response information, so that the statistical property will be reproduced by the model.

In the present invention, there is also provided a program for causing a computer to execute:

a first processing of extracting a statistical property of a characteristic value which reflects a physical phenomenon;

a second processing of acquiring response information to a preset parameter of the characteristic value simulated by a model which simulates the physical phenomenon; and

a third processing of determining the manner of variations of the preset parameter, based on the response information, so that the statistical property will be reproduced by the model.

In the apparatus, method and the program for determining a variation model, according to the present invention, the statistical property is determined by principal component analysis.

In the apparatus, method and the program for determining a variation model, according to the present invention, the response information is determined by calculating the deviation of the simulated characteristic value when the preset parameter is subjected to deviation.

In the apparatus, method and the program for determining a variation model, according to the present invention, the manner of variations of the preset parameter is determined as the result of singular value decomposition of a product of a response matrix and a transformation matrix and the result of principal component analysis are made to coincide with each other.

In the apparatus for determining a variation model, according to the present invention, there is further provided a simulation execution unit that executes simulation on the basis of the manner of variations of the preset parameter determined.

In the apparatus, method and the program for determining a variation model, according to the present invention, both the characteristic value and the simulated characteristic value are subjected to the same transformation.

In the apparatus, method and the program for determining a variation model, according to the present invention, the manner of variations of the preset parameter may be determined by a direct method.

In the apparatus, method and the program for determining a variation model, according to the present invention, coefficients or a transformation matrix that correlates the cause parameter with a parameter included in the model may be determined by regression analysis for the result of the principal component analysis.

In the apparatus, method and the program for determining a variation model, according to the present invention, a pseudo inverse matrix of a response matrix, a matrix comprising principal component vectors and an arbitrary unitary matrix may be multiplied to determine a transformation matrix.

In the apparatus, method and the program for determining a variation model, according to the present invention, an inverse matrix of a response matrix, a matrix comprising principal component vectors and an arbitrary unitary matrix may be multiplied to determine a transformation matrix.

In the apparatus, method and the program for determining a variation model, according to the present invention, a pseudo inverse matrix of a response matrix and a matrix comprising principal component vectors may be multiplied by each other to determine a transformation matrix.

In the apparatus, method and the program for determining a variation model, according to the present invention, an inverse matrix of a response matrix and a matrix comprising principal component vectors may be multiplied by each other to determine a transformation matrix.

In the apparatus, method and the program for determining a variation model, according to the present invention, a search method may further be carried out with the result of the direct method as an initial value.

In the apparatus, method and the program for determining a variation model, according to the present invention, the manner of variations of the preset parameter may be determined so that at least a part of the statistical property of the preset parameter will satisfy a preset condition.

In the apparatus, method and the program for determining a variation model, according to the present invention, a preset constraint condition is imposed on a trial value of a transformation matrix that transforms the cause parameter to a model parameter.

In the apparatus, method and the program for determining a variation model, according to the present invention, a preset constraint condition may be imposed on a trial value of a transformation matrix so that at least a part of the statistical property of the parameters will satisfy a preset condition.

In the apparatus, method and the program for determining a variation model, according to the present invention, a trial value of the transformation matrix may be determined by principal component analysis of the parameters.

In the apparatus, method and the program for determining a variation model, according to the present invention, parameter transformation may be made in such a way that a model parameter is deeded to be a function of another parameter.

In the apparatus, method and the program for determining a variation model, according to the present invention, the number of the cause parameter may be made lesser than the number of the model parameters to be varied.

In the apparatus, method and the program for determining a variation model, according to the present invention, the aforementioned transformation for matrix is a matrix for transforming the cause parameter into a model parameter.

In the apparatus, method and the program for determining a variation model, according to the present invention, in determining a variation model by determining a matrix G, wherein an equation VL=LΣ² holds, and a relationship RG=LΣU^{T}, U being a unitary matrix and T indicating transpose, at least approximately holds,

where R is an n′-row and m-column response matrix,

V is an n′-row and n′-column co-variance matrix of a characteristic value,

G is an m-row and M-column transformation matrix that transforms an M-dimensional vector of cause parameter, normalized to a standard deviation equal to 1, to an m-dimensional vector of model parameter,

L is an n′-row and M-column matrix having arrayed eigenvectors of M columns of V from the first column in the descending order of the eigenvalues, and

Σ is an M-row and M-column diagonal matrix having arrayed square roots √λ₁, √λ₂, . . . √λ_{M} of eigenvalues, λ₁, λ₂, . . . λ_{M} of V as diagonal elements;

G is solved by a direct method in which respective columns of G are determined so that respective columns of RG approximately coincide with respective columns of LΣU^{T}, wherein U is an arbitrary unitary matrix.

In the apparatus, method and the program for determining a variation model, according to the present invention, the transformation matrix G may be found as

G=(R^{T}R)⁻¹R^{T}LΣ

by linear regression analysis.

In the apparatus, method and the program for determining a variation model, according to the present invention, the transformation matrix G may be found as

G=(R^{T}R)⁻¹R^{T}LΣU^{T}

by linear regression analysis, where U is an arbitrary unitary matrix.

In the apparatus, method and the program for determining a variation model, according to the present invention, the normalized transformation matrix G, obtained by the direct method, may be subjected to singular value decomposition to obtain RG=L₁Σ₁U₁^{T}, where L₁ is an n′-row and M-column orthogonal matrix, with each column being of a length equal to 1, Σ₁ is an M-row and M-column diagonal matrix and U₁ is an M-row and M-column unitary matrix.

In the apparatus, method and the program for determining a variation model, according to the present invention, the transformation matrix G may be found by a search method in which the normalized transformation matrix G, obtained by the direct method, is used as a trial value, RG is subjected to singular value decomposition, where G is the trial value of G, the degree of coincidence between the principal component vectors of actual variations LΣ and the principal component vectors of reproduced variations L₁Σ₁ is checked, the trial value of G is adopted as G to be found, if a preset coincidence condition is met, and in which, in case of non-coincidence, another trial value of G is selected and re-tried.

In the apparatus, method and the program for determining a variation model, according to the present invention, in solving an equation RG=LΣU^{T}, U being a unitary matrix and T indicating transpose,

where R is an n′-row and m-column response matrix, V is an n′-row and n′-column co-variance matrix of a characteristic value, G is an m-row and M-column transformation matrix that transforms an M-dimensional vector of cause parameter, normalized to a standard deviation equal to 1, to an m-dimensional vector of model parameter, L is an n′-row and M-column matrix having arrayed eigenvectors of M columns of V from the first column in the descending order of the eigenvalues, Σ is an M-row and M-column diagonal matrix having arrayed square roots √λ₁, √λ₂, . . . √λ_{M} of eigenvalues, λ₁, λ₂, . . . λ_{M} of V as diagonal elements, and an equation VL=LΣ² holds, wherein

a trial value for G is selected,

a product of R and G is subjected to singular value decomposition to obtain RG=L₁Σ₁U₁^{T}, where L₁ is an n′-row and M-column orthogonal matrix, with each column of a length equal to 1, Σ₁ is an M-row and M-column diagonal matrix and U₁ is an M-row and M-column unitary matrix, the degree of coincidence between the principal component vectors of actual variations LΣ and those of reproduced variations L₁Σ₁ is checked, the trial value of G is adopted as G being found if a preset coincidence condition is met, and wherein, in case of non-coincidence, another trial value of G is selected and re-tried.

In the apparatus, method and the program for determining a variation model, according to the present invention, the standard deviation of the cause parameter is normalized to 1.

In the apparatus, method and the program for determining a variation model, according to the present invention, G′ that satisfies the relationship G=G′S, where G is a normalized transformation matrix, S′ is an M-row and M-column diagonal matrix having the values of standard deviation σ₁, σ₂, . . . σ_{M} of the cause parameters arrayed as the diagonal elements, may be used as a transformation matrix.

In the apparatus, method and the program for determining a variation model, according to the present invention, a normalized transformation matrix G is subjected to singular value decomposition to obtain G=G″SU₂^{T}, where G″ is an m-row and M-column orthogonal matrix with each column being of a length equal to 1, U₂ is an M-row and M-column unitary matrix and S is an M-row and M-column diagonal matrix having singular values s₁, s₂, . . . , s_{M} arrayed as the diagonal elements; and wherein

G″ is selected as a transformation matrix so that respective columns of the transformation matrix are of a length equal to 1 and orthogonal with respect to one another.

In the apparatus, method and the program for determining a variation model, according to the present invention, a co-variance matrix Vₚ of a model parameter is subjected to singular value decomposition to obtain VₚLₚ=LₚΣₚ², where Lₚ is an m-row and m-column orthogonal matrix having eigenvectors of Vₚ arrayed from the first column in the descending order of the eigenvalues and Σₚ is an m-row and m-column diagonal matrix having square roots √μ₁, √μ₂, . . . √μₘ of eigenvalues μ₁, μ₂, . . . μₘ of Vₚ arrayed as diagonal elements, and a matrix obtained on selecting part of columns of LₚΣₚ or LₚΣₚ with larger eigenvalues is used as a trial value of a normalized transformation matrix G.

### MERITORIOUS EFFECTS OF THE INVENTION

According to the present invention, the variation model, needed for executing circuit simulation that takes account of variations, may be determined quickly.

Still other features and advantages of the present invention will become readily apparent to those skilled in this art from the following detailed description in conjunction with the accompanying drawings wherein examples of the invention are shown and described, simply by way of illustration of the mode contemplated of carrying out this invention. As will be realized, the invention is capable of other and different examples, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a block diagram showing the configuration of a first exemplary embodiment according to the present invention.

FIG. 2 is a graph showing device characteristics for illustrating the operation of the first exemplary embodiment according to the present invention.

FIG. 3 is a graph showing device characteristics for illustrating the operation of the first exemplary embodiment according to the present invention.

FIG. 4 is a graph showing transformed device characteristics for illustrating the operation of the first exemplary embodiment according to the present invention.

FIG. 5 is a flowchart for illustrating the operation of the first exemplary embodiment according to the present invention.

FIGS. 6A and 6B are flowcharts for illustrating the operation of the first exemplary embodiment according to the present invention.

FIG. 7 is a graph showing the standard deviation of principal components for illustrating the operation of the first exemplary embodiment according to the present invention.

FIG. 8 is a graph showing direction vectors of principal components for illustrating the operation of the first exemplary embodiment according to the present invention.

FIG. 9 is a graph showing the standard deviation of principal components for illustrating the operation of the first exemplary embodiment according to the present invention.

FIG. 10 is a graph showing direction vectors of principal components for illustrating the operation of the first exemplary embodiment according to the present invention.

FIG. 11 is a block diagram showing the configuration of a second embodiment of the present invention.

### EXPLANATIONS OF SYMBOLS

100 variation analysis unit
200 model analysis unit
300 fitting execution unit
400 simulation execution unit
500 result output unit
901, 902 variation simulation systems

### PREFERRED MODE FOR CARRYING OUT THE INVENTION

Next, exemplary embodiments of the present invention will be described in detail with reference to the drawings.

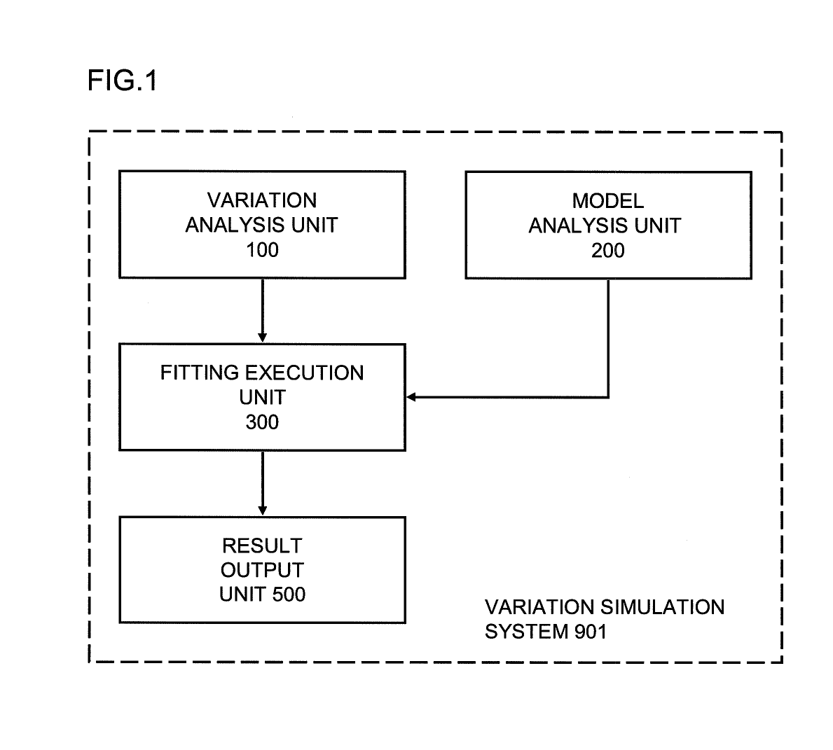

Referring to FIG. 1, a variation simulation system 901 according to a first exemplary embodiment of the present invention includes a variation analysis unit 100, a model analysis unit 200, a fitting execution unit 300 and a result output unit 500.

The variation analysis unit 100 acquires the results of statistical analysis of variations of characteristics of a plurality of target devices.

The model analysis unit 200 acquires the results of analysis of what responses the characteristics of a model that simulates the target device will have to variations of parameters.

The fitting execution unit 300 collates the results obtained with the variation analysis unit 100 to those obtained with the model analysis unit 200 to determine how the parameters are to be varied in order for the model to reproduce the variations of the target devices.

The information on how the parameters are to be varied, thus determined by the fitting execution unit 300, is output by the result output unit 500.

In the first exemplary embodiment of the present invention, the variation analysis unit 100 acquires characteristic data of a plurality of, herein N, target devices, the characteristics of which are being varied due to variations. The characteristic data, such as current-to-voltage characteristics or capacitance-to-voltage characteristics, may be obtained by measurements conducted on actually fabricated N number of devices. Or, the characteristic data may be obtained by forming N number of simulated devices on a computer, using e.g. the process simulation that takes the phenomenon of variations into account, and by computing the characteristics of these simulated devices by device simulation.

Further, in the first exemplary embodiment of the present invention, the aforementioned measurement or process/device simulation may be separately carried out and the resulting characteristic data may be delivered to the variation analysis unit 100. Alternatively, the functions of the measurements or process/device simulation may be included in the variation analysis unit 100.

It is also possible for the variation analysis unit 100 to transform characteristic data, as necessary, using an arbitrary function, before proceeding to extract the aforementioned statistical data.

The variation analysis unit 100 carries out statistical analysis of the aforementioned characteristic data of the devices to extract statistical data. The characteristic data may be data already subjected to transformation of characteristics as necessary. For this extraction, principal component analysis, for example, may be used.

The model analysis unit 200 acquires a device model for circuit simulation (center model) that reproduces representative characteristics of the target devices. This center model may be acquired by selecting a sole device, exhibiting center characteristics, out of a large number of devices, and by carrying out a known parameter extraction procedure on the so selected device.

This parameter extraction procedure may separately be carried out and the set of parameters obtained thereby may then be delivered to the model analysis unit 200. Or, the function of carrying out the parameter extraction procedure may be included in the model analysis unit 200.

The model analysis unit 200 determines how much the device characteristics, as measured by circuit simulation, are varied against variations of preset one or more parameters. That is, the model analysis unit 200 measures the response of device characteristics to changes in the parameter values. It is noted that, in case the variation analysis unit 100 performs the aforementioned transformation of characteristics, the above response is determined of the characteristics of the devices subjected to the same transformation of characteristics.

The aforementioned preset parameters used may be selected from model parameters for circuit simulation that constitutes the center model. Or, parameter transformation may be carried out as necessary to generate parameters different from those intrinsic parameters for circuit simulation.

From the above, there is obtained a response matrix representing the response of characteristic data, following the transformation of characteristics, to preset parameters.

In the above description, the model analysis unit 200 acquires a device model by itself and computes the response of the so acquired device model. However, the present invention is not restricted to this technique if the model response can be acquired by some means or other. That is, in the model analysis unit 200, means to acquire the model response is selectable, provided that the model analysis unit 200 is able to acquire the model response after all.

It is sufficient that the model response is acquired for a given device model only once and the result is being saved. That is, the operation of acquiring the model response need not be carried out repeatedly. If the model response has already been known, such known model response may be read into the model analysis unit 200.

Part or all of the sequence of determining the model response, such as operation of simulation with variations of the values of the parameters, may separately be carried out, and the results of these operations may then be read into and used by the model analysis unit 200.

The fitting execution unit 300 determines the manner of variations of the above-mentioned preset parameter, in such a way that the manner of variations of the device characteristics as found by the variation analysis unit 100 will be substantially reproduced by the above-described model for simulation. At this time, the information on the response of the model for simulation, which has been determined by the model analysis unit 200, is used.

The manner of variations of the preset parameters, described above, may be determined by determining the magnitude of the variations of one or more parameters which are deemed to be responsible for variations (referred to below as ‘cause parameters’), and a function expression that correlates the aforementioned preset parameters with the cause parameters.

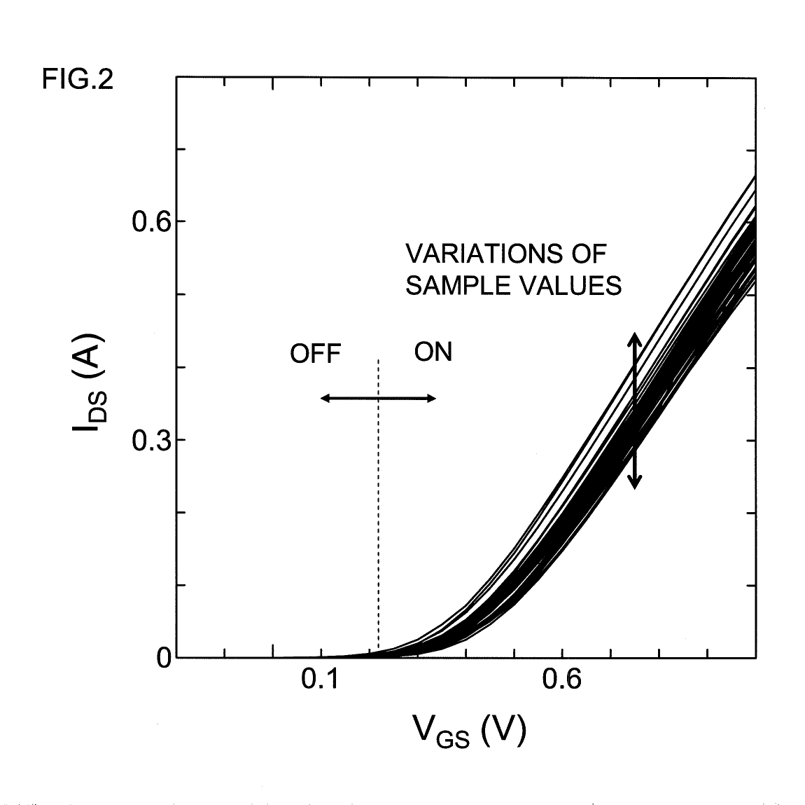

The entire operation of the present exemplary embodiment is now described in detail with reference inter alia to FIGS. 1 and 2. Although the manner of execution of the present invention is variegated, a specified example will be taken up in the following to facilitate the description.

The variation analysis unit 100 acquires N device characteristic data. This may be accomplished by reading in a preset file, having stored characteristic data, subject to user's instructions. These characteristic data may be provided by conducting measurements on real devices and saving the results in a file in a preset form.

Typical desirable device characteristic data are made up of values of measured data, such as current or capacitance values, under a preset plurality of, for example, n number of bias conditions. In this case, the device data are a list of a number of numerical values (elements) equal to the number of bias points n multiplied by the number of devices N. The measured value under the i'th bias condition is deemed to be a stochastic variable and labeled yi, and specified values of yi for each of the N number of devices are deemed to be sampled values of the stochastic variables yi.

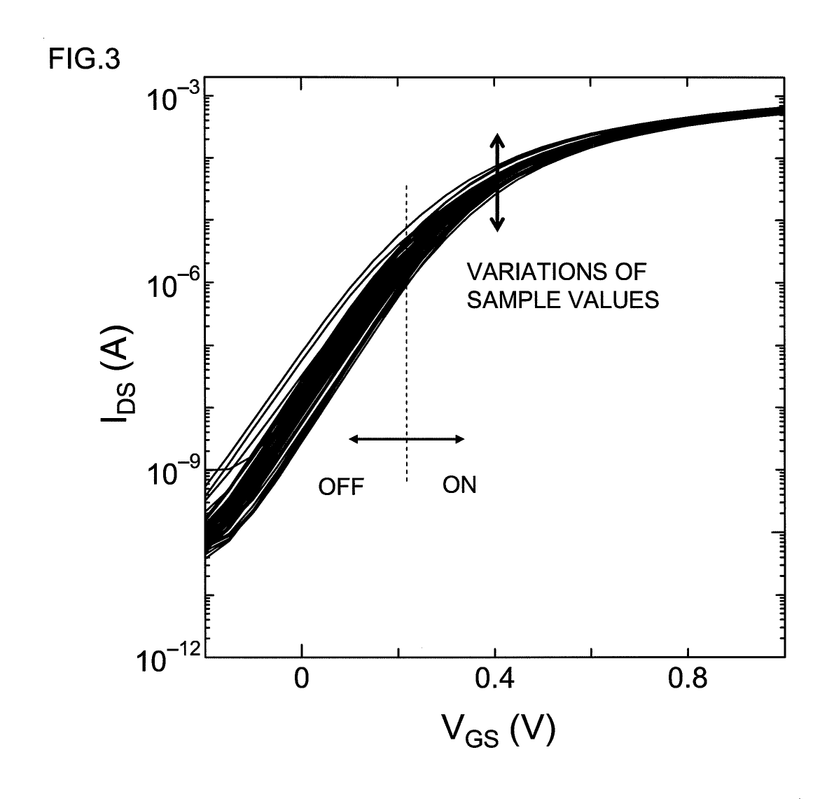

Real examples of the above-described device characteristic data are shown in FIGS. 2 and 3. Although the same data are shown in FIGS. 2 and 3, the linear scale and the log scale are used for the ordinate in FIG. 2 and in FIG. 3, respectively.

The graphs of FIGS. 2 and 3 show the measured results of a drain-to-source current IDS of an n-channel MOSFET. As for the bias conditions, the drain-to-source voltage VDS is 1V, the substrate-to-source voltage VBS is 1V and the gate-to-source voltage VGS is varied from −0.2V to 1.0V at steps of 0.05V. A large number of curves represent characteristics of separate MOSFETs formed with the same design. These curves are spread apart from one another as a result of variations.

The respective curves on the graph each appear to be a continuous solid curve by reason of small steps of VGS and, in actuality, each curve is made up of 25 discrete data along the horizontal axis, that is, n=25.

In the present example, IDS under the i'th bias condition is the stochastic variable yi. The N number of measured values of IDS, as sampled values of yi, are statistically varied due to variations.

The variation analysis unit 100 applies transformation of characteristics to the stochastic variables as necessary. In terms of a mathematical equation, the variation analysis unit 100 performs the transformation of the following equation (1):

yᵢ′=fᵢ(y₁, y₂, . . . , yₙ) (i=1, 2, . . . , n′) (1)

where yi′ is the as-transformed stochastic variable.

The simplest method of transformation of characteristics is to divide each yi by a preset constant to yield yi′.

As this constant, it is possible to use the value of expectation or the value of standard deviation of yi. Thus, data weight at each yi may be adjusted so that the variation at each i is not overestimated or underestimated.

A preferred equation for transformation for the actual example of FIG. 3 may be given by the following equation (2):

$${{y}_{i}}^{′} = \frac{{y}_{i}}{a} + \frac{log ( {y}_{i} / a )}{log ( a / b )} ( i = 1 , 2 , … , {n}^{′} , {n}^{′} = n ) \qquad ( 2 )$$

where a and b are constants.

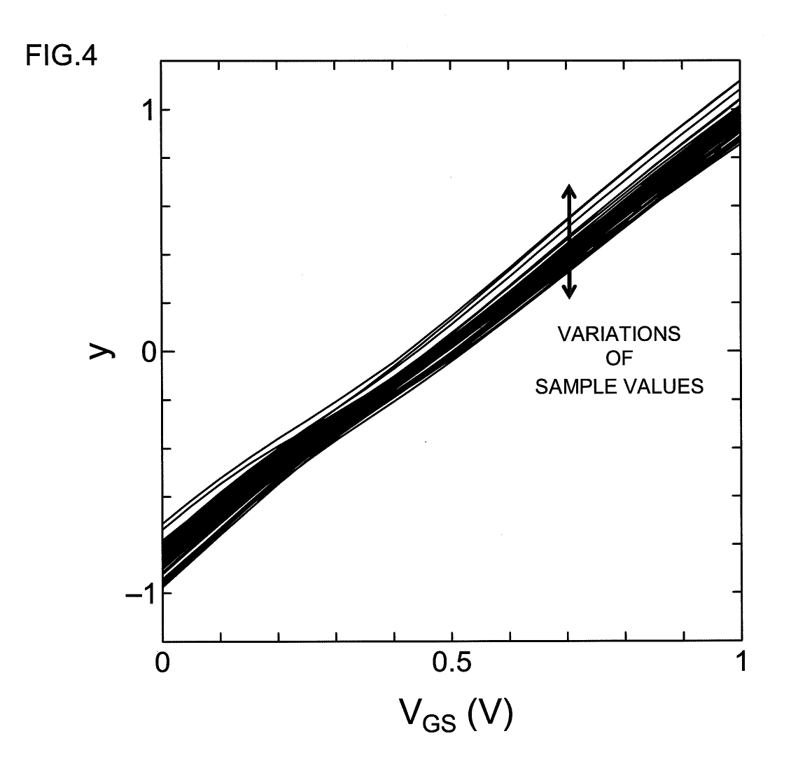

The graph of FIG. 4 shows the relationship between yi′ after transformation and VGS for a=0.3 mA and b=0.1 mA.

The reason the transformation of the equation (2) is desirable is as follows:

It is seen from FIG. 2 that, if VGS is larger, that is, if the MOSFET is on, the values of IDS, that is, yi, are subjected to marked variations, whereas, if VGS is smaller, that is, if the MOSFET is cut off, the variations of IDS, that is, yi, are hardly discernible on the drawing.

Hence, if statistical analysis is performed on yi per se, most of the information on the variations in the off state is lost.

Reference to FIG. 3, which uses the log scale for the vertical axis, indicates that small leakage current flows even under the off state, with the value of the leakage current varying appreciably on the log scale.

When it is desired to simulate the variations in the off state to high accuracy, it is not proper to use yi per se as the stochastic variable.

Reference to FIG. 4 indicates that, as a result of the transformation according to the equation (2), the value of yi′ shows variations which remain approximately the same in the on and off states.

Thus, if the equation (2) is used, the variations in the on state and those in the off state may be handled with equivalent weight.

It is seen from above that the equation for transformation (1) may suitably be selected so that the variations of yi will be larger in magnitude under the bias condition to which importance is to be attached in connection with the variations. As the case may be, the transformation may be dispensed with (that is, y1′ may remain equal to y1).

For the examples of FIGS. 2 and 3, the equation (2) is suited for the case where importance is to be equally attached to the on state and to the off state. The transformation may be dispensed with if the variations in the off state may safely be disregarded.

By specifying the method for transformation of characteristics in this manner, it is possible for the user to decide on a guideline of simulation, that is, to decide on which part of the device characteristics importance is to be attached to in carrying out the simulation.

The number n′ of the stochastic variables after the transformation of characteristics does not have to be equal to the number n. For example, if the number of the bias points n of the data measured is unnecessarily large to cause impediments to subsequent processing, thinning to reduce n′ may be appropriately performed at the time of the transformation.

Additionally, the stochastic variables after the transformation may be selected characteristic values that may be extracted from the measured data, such as threshold voltage value or on-current (IDS under a preset conduction bias state).

The variation analysis unit 100 performs statistical analysis on the stochastic variable yi′ to extract statistic characteristics.

As the technique, used therefor, the method of principal component analysis may be used. Specifically, the covariance matrix V of the characteristic values of the following equation (3) is calculated.

$$V = ( \begin{matrix}{V}_{11} & {V}_{12} & … & {V}_{1 {n}^{′}} \\ {V}_{21} & {V}_{22} & … & {V}_{2 {n}^{′}} \\ ⋮ & ⋮ & ⋱ & ⋮ \\ {V}_{{n}^{′} 1} & {V}_{{n}^{′} 2} & … & {V}_{{n}^{′} {n}^{′}}\end{matrix} ) , {V}_{ij} = \overline{{{y}_{i}}^{′} {{y}_{j}}^{′}} - \overline{{{y}_{i}}^{′}} - \overline{{{y}_{j}}^{′}} \qquad ( 3 )$$

The over-bars on the stochastic variables indicate taking average values of the stochastic variables.

The eigenvalues and the eigenvector of the covariance matrix V are then obtained using a proper eigenvalue decomposition algorithm. It is noted that the eigenvectors are to satisfy the following equation (4):

$$V ( \begin{matrix}{l}_{11} \\ {l}_{21} \\ ⋮ \\ {l}_{{n}^{′} 1}\end{matrix} ) = {λ}_{1} ( \begin{matrix}{l}_{11} \\ {l}_{21} \\ ⋮ \\ {l}_{{n}^{′} 1}\end{matrix} ) , V ( \begin{matrix}{l}_{12} \\ {l}_{22} \\ ⋮ \\ {l}_{{n}^{′} 2}\end{matrix} ) = {λ}_{2} ( \begin{matrix}{l}_{12} \\ {l}_{22} \\ ⋮ \\ {l}_{{n}^{′} 2}\end{matrix} ) , … \qquad ( 4 )$$

where λ₁, λ₂ and so forth are eigenvalues and column vectors lying on left and right sides of the associated eigenvalues are eigenvectors associated with the eigenvalues.

The eigenvalues are sorted in the descending order from the large value side. The lengths of the eigenvectors are normalized to 1. There are n′ eigenvalue-eigenvector sets at the maximum.

z1 given by the following equation (5) is termed the first principal component of a set of stochastic variables yi′ (i=1, 2, . . . n′). The variance of z1 is known to be equal to λ₁.

z₁=l₁₁y₁′+l₂₁y₂′+ . . . +lₙ₁y_{n′} (5)

The equation (6), given below, is the second principal component, and has the second largest variance λ₂. The higher order principal components are defined in a similar manner.

z₂=l₁₂y₁′+l₂₂y₂′+ . . . +lₙ₂y_{n′} (6)

The covariance of the different principal components is zero, that is, these components are uncorrelated with one another.

An i'th eigenvector is a direction vector indicating the direction of the i'th principal component. This vector multiplied by the value of the variations of the i'th principal component (standard deviation, that is, the square root of λᵢ), is termed an ‘i'th principal component vector’. The different principal component vectors have the property that they are orthogonal to each other.

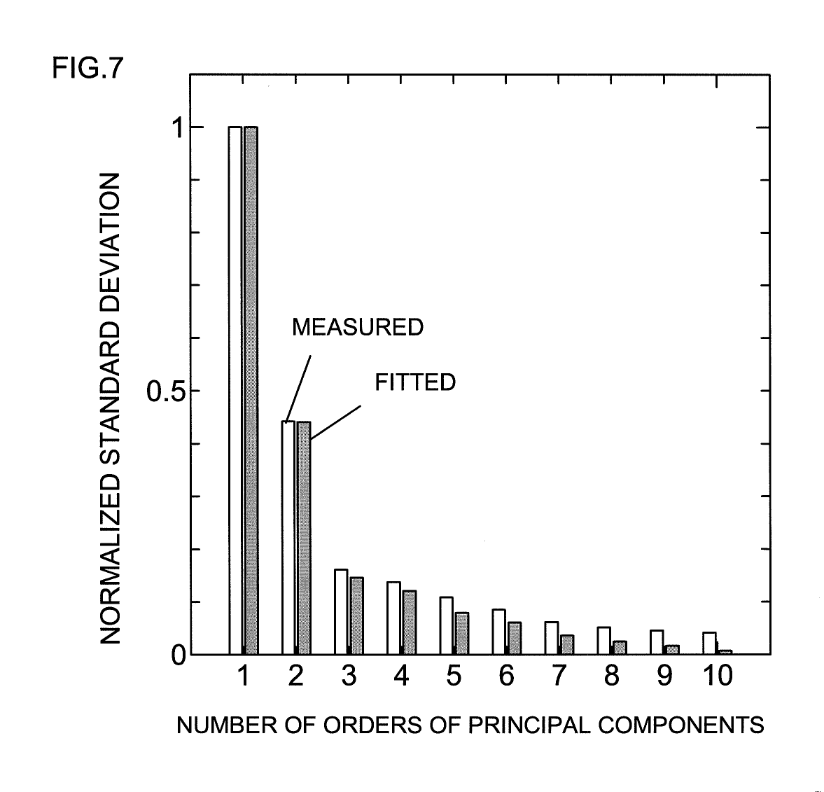

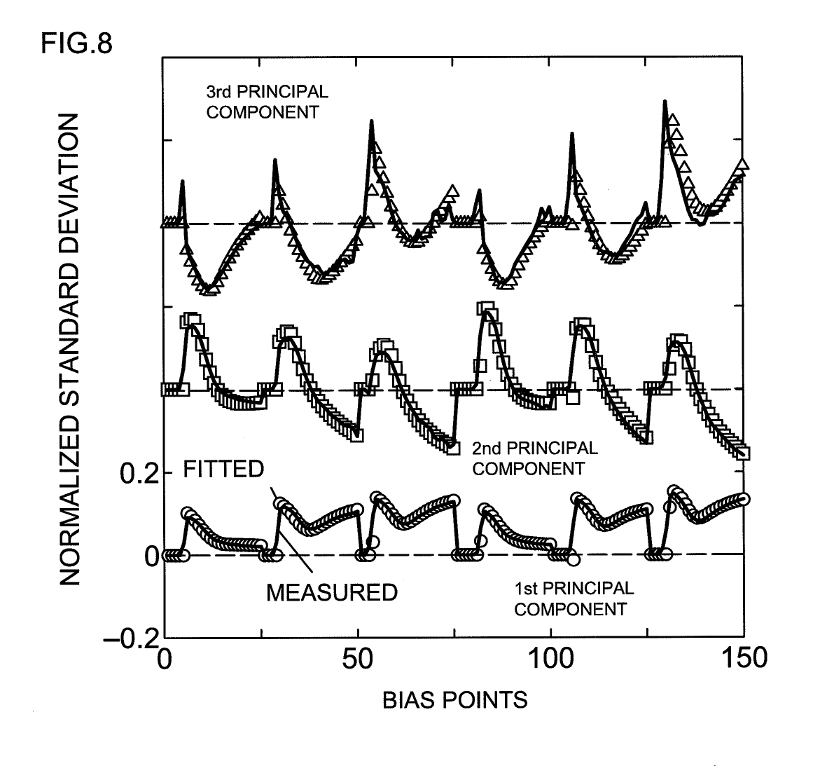

FIGS. 7 and 8 show examples of principal component analysis. In FIG. 7, the horizontal axis and the vertical axis denote the number of orders of the principal components and the normalized standard deviation (square root of variance), respectively.

The examples of FIGS. 7 and 8 show the results of calculations obtained for the example shown in FIGS. 2 to 4 with addition of other bias points to give a total of 150 bias points. The above results of calculations are obtained with the use of data for any combination of one of 1V, 0.525V and 0.05V of VDS, one of 0V and −0.5V of VBS and one of a number of values from −0.2V to 1V of VGS at a step of 0.02V.

In FIG. 7, unshaded bar graphs, labeled ‘measured’, denote the values of the standard deviation (square root of variance), normalized to the value of the first principal component, of the first to tenth principal components as obtained from measured data.

In FIG. 8, showing the relationship between the bias points (abscissa) and the eigenvector components, the solid-line plots, labeled ‘measured’, represent eigenvector components for the first to third principal components, as obtained with the actual data. It is noted however that the plots for the second and third principal components are shown deviated by 0.4 and 0.8 upwards, respectively, for ease in seeing the drawing.

As may be seen from the equation (4), the eigenvector in the present example is a vector having n′=n=150 components.

The model analysis unit 200 acquires a center model, as necessary.

The device characteristics are varied due to variations. The center model is a device model located at the center of an area of the variations, in other words, a device model having typical device characteristics.

The center model may be acquired by selecting one out of a large number of devices having center characteristics and by carrying out the conventional parameter extraction procedure on the so selected device.

The model analysis unit 200 investigates, by circuit simulation, into the response of the values of device characteristics against preset parameters included in the so acquired center model. At this time, the model analysis unit 200 invokes a circuit simulator, as necessary, to acquire the results. The circuit simulator may be provided within the variation simulation system 901 or provided externally, as desired.

The model analysis unit 200 causes deviation of m number of preset parameters by preset amounts from the center values and checks for resulting deviations of the values of the device characteristics that may be calculated at this time by circuit simulation. The so deviated preset parameters are the parameters to be statistically varied to simulate measured variations, and may arbitrarily be selected. It is noted that the values of device characteristics, the response of which is to be checked, should be equivalent to those used in the variation analysis unit 100.

In the case of the above example, the current-to-voltage characteristic, computed by simulation under the same bias conditions as those used for measurements, is used.

In case the variation analysis unit 100 effects the transformation of characteristics, the characteristic values used are obtained after the corresponding transformation of characteristics.

The response of the values of the device characteristics to the selected preset parameter represents transformation from a form with m number of inputs to a form with n′ number of outputs, and may be expressed as a matrix.

The deviation of an i'th transformed characteristic value yi′, obtained on deviation of a j'th parameter pj by a preset amount of deviation Δpj, is calculated and divided by the preset deviation Δpj to yield rij, where i=1, . . . , n′ and j=1, . . . , m.

rij is approximately equivalent to partial differential of yi′ with respect to pj. A matrix R having rij as an element of an i'th row j'th column is defined as a response matrix.

$$R = ( \begin{matrix}{r}_{11} & {r}_{12} & … & {r}_{1 m} \\ {r}_{21} & {r}_{22} & … & {r}_{2 m} \\ ⋮ & ⋱ & ⋱ & ⋮ \\ {r}_{{n}^{′} 1} & {r}_{{n}^{′} 2} & … & {r}_{{n}^{′} m}\end{matrix} ) , {r}_{ij} ≡ \frac{\partial {{y}_{i}}^{′}}{\partial {p}_{j}} \qquad ( 7 )$$

In the case of the above example, if the gate length LG is to be among the preset parameters, the current-to-voltage characteristic of a MOSFET is calculated by circuit simulation, first with a value of LG reduced by ΔLG/2. The current values IDS, that is, yi, at respective bias points, are calculated, and transformed in accordance with the equation (1) or (2), to calculate yi′.

Similar calculations are conducted for LG enlarged by ΔLG/2 to calculate yi′.

yi′ from the former calculations is subtracted from yi′ of the latter to find the deviation of yi′ which is then divided by ΔLG to find each matrix element of the equation (7).

In calculating the deviation of yi′, it is preferred to perform the calculations as pj is deviated in both the positive and negative directions by −Δpj/2 and Δpj/2 from a center value.

In the above description, it is assumed that the model analysis unit 200 acquires a device model for itself and uses it to calculate the model response. The present invention is not restricted to this technique if the model response may be acquired by some means or other. That is, it suffices if the model analysis unit 200 is able to acquire the model response by any suitable means.

For example, part or all of the sequences of operations that determine the model response are carried out by separate operations and the results thereof may then be read in and used. More specifically, the model analysis unit 200 may directly read-in the respective elements of the response matrix.

The model analysis unit 200 may also read-in a set of data needed for calculating the elements of the response matrix. For example, the model analysis unit 200 may read-in a set of characteristic values yi, for all possible values of the combinations of i and j, as obtained when the parameters pj are deviated by preset shift values of Δpj/2 and −Δpj/2. The model analysis unit may then calculate the elements of the response matrix R, based on the so read-in data.

The fitting execution unit 300 then determines the manner of variations of the above-mentioned preset parameters, based on the information, determined as described above, so that the manner of variations of the device characteristics as found by the variation analysis unit 100 will be approximately reproduced by the simulation model.

To reproduce actual variations on the simulation model, the concept of ‘cause parameter’ is here introduced.

The cause parameter is such a parameter the statistical variations of which may be considered to be responsible for producing variations in the device characteristics.

The number of the cause parameters may arbitrarily be selected. The greater the number of the cause parameters, the higher is the possibility to accurately reproduce the variations.

The cause parameters, which are different from one another, are preferably selected so as to be varied without being correlated to one another.

According to the present invention, by the term ‘parameter’ is meant not the cause parameter but rather the model parameter, unless otherwise specified.

The number of the cause parameters, which is M, is normally lesser than or equal to n′.

It is noted that, in carrying out the circuit simulation, the greater the number of the cause parameters per device, the more is the number of the dimensions of the variation-space and the more difficult is the circuit analysis.

Hence, the number of the cause parameters is to be a necessary minimum number, whereby it is easier to carry out simulation in a manner which takes variations into account. In particular, in simulating a large-size system, the number of the cause parameters desirably is not larger than two and is more desirably is equal to unity.

On the other hand, a larger number n′ of the model parameters to be varied does not causes an appreciable impediment and hence it is desirable to increase its number as necessary to improve the accuracy of the variation model. Typically, the number of the model parameters ranges from two to several tens.

By selecting the cause parameters without correlation to one another, it becomes easier to carry out the Monte-Carlo simulation which determines the cause parameters by random numbers.

As a special case, one of the model parameters may be a cause parameter.

The model parameter and the cause parameter are correlated with one another in accordance with the following equation:

pⱼ=gⱼ(x₁, x₂, . . . , x_{M}) (j=1, . . . , m) (8)

where xi is the cause parameter. If the cause parameters are varied statistically, the model parameters are varied, in accordance with the equation (8), and further the characteristic values represented by the model are varied.

The manner of variations of the preset parameter may be determined by determining the value of the variations of the cause parameter and the equation (8) that correlates the aforementioned preset parameter and the cause parameter.

The information that prescribes the manner of variations of the preset parameter is termed a ‘variation model’.

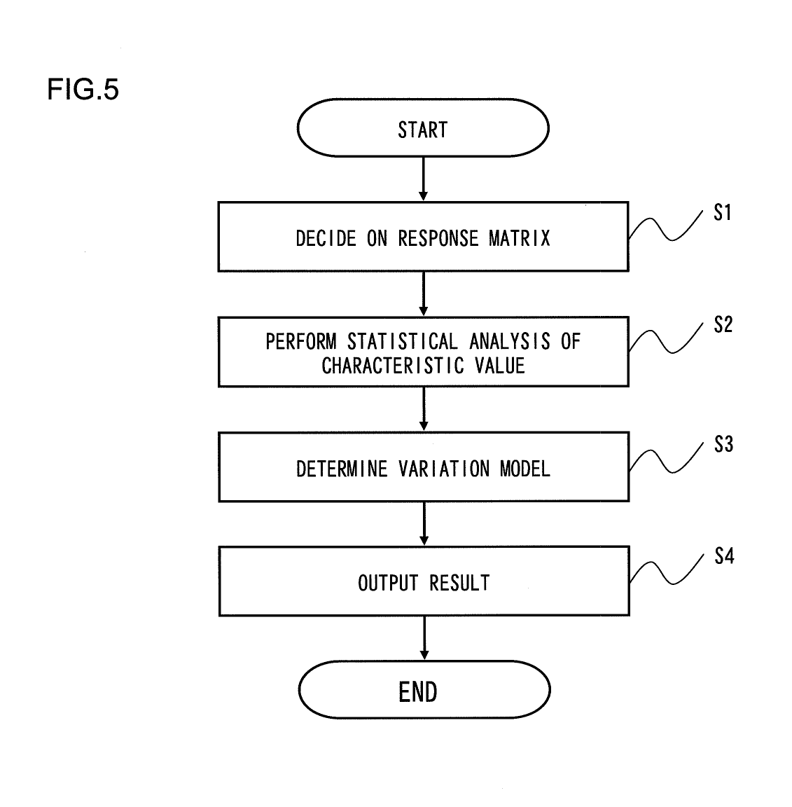

The fitting execution unit 300 determines the variation model by determining the value of the variations of the cause parameter and the equation (8) that correlates the aforementioned preset parameter and the cause parameter (step S3 of FIG. 5).

The equation (8) is universal and its manner of determination is excessively arbitrary. Hence, for practical purposes, the equation (8) is preferably restricted, by linear approximation, to the form of the following equation:

$$( \begin{matrix}Δ {p}_{1} \\ Δ {p}_{2} \\ ⋮ \\ Δ {p}_{m}\end{matrix} ) = G ( \begin{matrix}Δ {x}_{1} \\ Δ {x}_{2} \\ ⋮ \\ Δ {x}_{M}\end{matrix} ) , G = ( \begin{matrix}{g}_{11} & {g}_{12} & … & {g}_{1 M} \\ {g}_{21} & {g}_{22} & … & {g}_{2 M} \\ ⋮ & ⋮ & ⋱ & ⋮ \\ {g}_{m 1} & {g}_{m 2} & … & {g}_{mM}\end{matrix} ) \qquad ( 9 )$$

where G, termed a transformation matrix, is a matrix having constants as elements, and Δ denotes deviation from the center value.

It is thus seen that the equation (8) may be determined by determining the elements of the matrix G.

For simplicity of description, it is assumed below that, unless otherwise specified, the cause parameter has the center value equal to zero.

It is thus assumed that Δxi=xi. The center value of xi may thus be defined without losing universality.

It is because the equation (9) is not affected by adding an arbitrary constant value to xi.

In the following, it is further assumed that the value of the fluctuation (standard deviation) of the cause parameter xj is normalized to 1, unless otherwise specified.

Even if the values of the variations of the cause parameter are limited in this manner to 1, the generality is not lost. The reason is that, if the standard deviation of the j'th cause parameter is K, and this cause parameter is multiplied by 1/K to normalize its standard deviation to 1, at the same time as the j'th column of the matrix is multiplied by K, the manner of variations of the model parameter by the equation (9) is not changed. That is, the expression of the variations of the cause parameter equal to K is equivalent to that of the variations of the cause parameter equal to 1, and hence the case where the variations of the cause parameter equal to 1 may be used to represent other cases. It is noted that, when desired to clarify that the transformation matrix corresponds to the cause parameter normalized to the standard deviation equal to 1, G is termed the normalized transformation matrix.

The fitting execution unit 300 is able to determine the matrix G of the equation (9) as follows:

If attention is focused on the first to the M′th principal components, the equation (4) may be represented by a matrix of the form of

$$VL = L {Σ}^{2} , Σ = ( \begin{matrix}\sqrt{{λ}_{1}} & 0 & … & 0 \\ 0 & \sqrt{{λ}_{2}} & ⋱ & ⋮ \\ ⋮ & ⋱ & ⋱ & 0 \\ 0 & … & 0 & \sqrt{{λ}_{M}}\end{matrix} ) , \\ L = ( \begin{matrix}{l}_{11} & {l}_{12} & … & {l}_{M} \\ {l}_{21} & {l}_{22} & … & {l}_{M} \\ ⋮ & ⋮ & ⋱ & ⋮ \\ {l}_{{n}^{′} 1} & {l}_{{n}^{′} 2} & … & {l}_{M}\end{matrix} ) \qquad ( 10 )$$

Using this representation, G may be determined by the following equations:

R⁺=(R^{T}R)⁻¹R^{T}

G=R⁺LΣ (11)

In the above equations, superscript T operates on the matrix on its left side and means transpose of the matrix. The superscript −1 operates on the matrix on its left side and means its inverse matrix. The matrix R+ is termed a pseudo inverse matrix of a matrix R.

Matrices L and Σ are provided by the variation analysis unit 100.

The matrix R is provided by the model analysis unit 200. Based on the above information, the fitting execution unit 300 is able to determine the transformation matrix G in accordance with the equations (11).

The result output unit 500 outputs the information on the variation model determined by the fitting execution unit 300.

The result output unit typically outputs a list of elements of the transformation matrix G. In addition, the result output unit outputs the reference information, such as the information on the matrices R and LΣ or on fitting accuracy.

Based on the output information of the result output unit 500, the circuit simulation, such as Monte Carlo simulation, may be carried out as appropriate.

The flowchart for the above-described operations is shown in FIG. 5. The flow includes a step S1 for determining the response matrix R, a step S2 of carrying out the statistical analysis of the characteristic value (principal component analysis), a step S3 of determining the variation model and a step S4 of outputting the result.

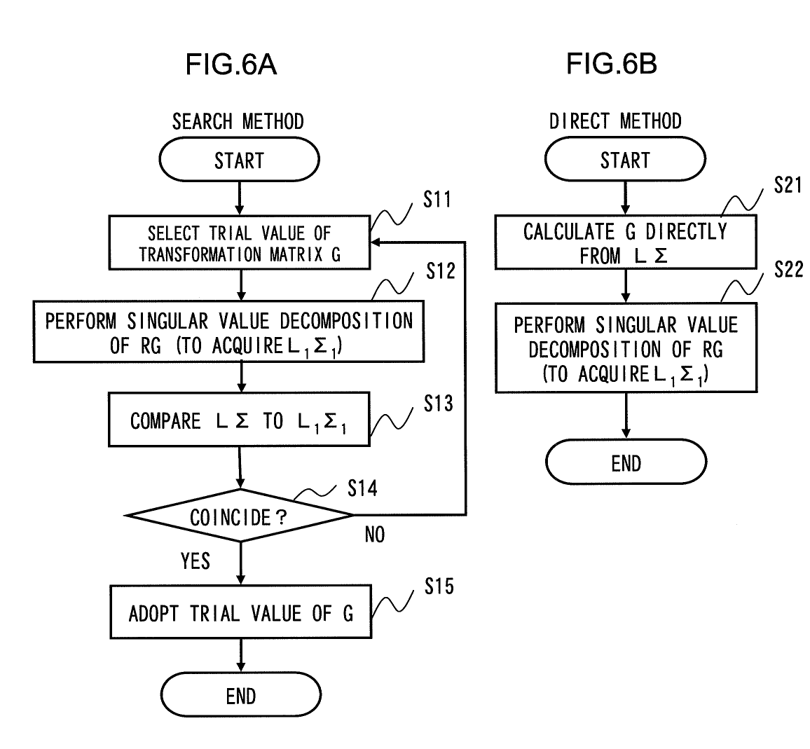

The operation of the fitting execution unit 300 is now described in further detail with reference to FIG. 6.

FIG. 6A describes the step S3 of determining the variation model in greater detail.

A column vector, having cause parameters x1, x2, . . . , xM as elements, is indicated as x for short.

A column vector, having characteristic values Δy1′, Δy2′, . . . , Δyn′ as elements, is indicated as y for short.

The situation that the characteristic values are varied due to variations of the cause parameters may be expressed, by linear approximation, by the following equation:

y=Ax (12)

where A is a matrix of n′ rows and M columns. Using this matrix, the covariance matrix V, defined by the equation (3), may be modified to the form of the following equation:

V= y̅y̅^̅{̅T̅}̅= (̅A̅x̅)̅(̅x̅^̅{̅T̅}̅A̅^̅{̅T̅}̅)̅ (̅A̅x̅)̅(̅x̅^̅{̅T̅}̅A̅^̅{̅T̅}̅)̅=A x̅x̅^̅{̅T̅}̅A^{T}=AA^{T} (13)

As aforesaid, it is assumed here that the elements of x have an average equal to zero and have the standard deviation normalized to 1. Using this equation, the equation (10), expressing the principal component analysis, may be modified to the form of the following equations (10):

VL=LΣ²

AA^{T}L=LΣ²

AA^{T}=LΣ²L^{T}=(LΣU^{T})(UΣL^{T}) (14)

where the matrix U is an arbitrary M-row and M-column unitary matrix. By the unitary matrix is meant a square matrix having both a row vector and a column vector equal to 1 in length and orthogonal to each other. The unitary matrix thus corresponds to coordinate rotation without changing the length. In modifying the above equation, the fact that a product of L and its transposed matrix is a unit matrix, and that a product of U and its transposed matrix is also a unit matrix, is used.

It is seen from above that as-measured variations may be reproduced by the variations of the cause parameters if the matrix A satisfies the following equation:

A=LΣU^{T} (15)

On the other hand, from the equations (7) and (9), the following relationship holds:

y=Ax=RΔp=RGx

A=RG (16)

where a column vector having parameter deviations Δp1, Δp2, . . . , Δpm as elements are denoted as Δp for short.

It is seen from above that determination of the variation model reduces to the problem of determining the matrix G for which the relationship

RG=LΣU^{T} (17)

holds approximately.

One method for solving the problem according to the present invention is the method of conducting optimum value search through trial and error. This method is herein termed a ‘search method’. This method comprises the following steps (see FIG. 6A):

### Step 1:

A trial value of the matrix G is selected as appropriate (step S11 of FIG. 6A).

### Step S2:

A product of R and G (trial value) is transformed to the following form:

RG=L₁Σ₁U₁^{T} (18)

where L₁ is a matrix with n′ rows and M columns, having a length each equal to 1 and orthogonal one another,

Σ₁ is an M-row and M-column diagonal matrix, and

U₁ is an M-row and M-column unitary matrix.

The transformation of the matrix to a form shown on the right side of the equation (18) is termed a ‘singular value decomposition’ (step S12 of FIG. 6A).

It is noted that L₁, Σ₁ and U₁ are matrices uniquely determined when RG is determined. These matrices are, however, different in general from L, Σ and U of the equation (17).

### Step 3:

It is checked whether or not LΣ and L1Σ1 approximately coincide with each other (step S13 of FIG. 6A).

If the preset condition for coincidence is satisfied (YES of step S14 of FIG. 6A), the trial value of the matrix G, selected in the step S1, is determined as being the desired G (step S15 of FIG. 6A). If the preset condition for coincidence is not satisfied (NO of step S14 of FIG. 6A), the program returns to the step S1.

In the equation (17), U is an arbitrary unitary matrix.

From the definition of the singular value decomposition, it is apparent that U₁ is a unitary matrix. It is therefore unnecessary to take coincidence between U and U₁ into account.

The above decision on approximate coincidence may be made using a proper evaluation function. A desirable example for the evaluation function is a function obtained on summing the square values of the differences (distances) between the i'th column vectors of LΣ (i'th principal component vectors) and the i'th column vectors of L1Σ1 for a preset range of i.

This evaluation function is equivalent to a fitting error. It is sufficient that i ranges e.g. from 1 to the maximum number of the orders of the principal components desired to be reproduced by the variation model.

Usually, when M cause parameters are used, it is likely that up to the M′th principal component at the maximum can be reproduced. It is therefore most natural that the range of i is from 1 to M.

In the step S3, it is sufficient to use the evaluation function reaching the minimum value, that is, reaching an optimum solution within a preset error range, as being a condition of coincidence.

In the above-described method, the problem of global optimization is solved, where the errors of all principal components of interest expressed by a sole evaluation function is minimized.

To this end, singular value decomposition is iteratively carried out each time the evaluation function is calculated. In general, the singular value decomposition can be solved not by a direct method but only by a reiterative method. Hence, the above-mentioned optimization reduces to the problem of a so-called non-linear optimization. In general, the algorithm for optimization includes trial and error.

If the above-described global optimum value search is carried out, it is possible to find out G which will give the practically best coincidence between the variations represented by the variation model (having the principal component vector of L1Σ1) and actual variations (having the principal component vector of LΣ). With such G, the equation (17) is to hold with optimum approximation.

However, with this method, the search time tends to be prolonged in case there are many unknown numbers to be determined.

In case of using a quasi-Newton method or a downhill simplex method of sequentially tracing the evaluation function in order in search for an optimum value, the search time may be suppressed to some extent. However, if there are local optimum point(s) at which the evaluation function assumes locally extremal value(s), in addition to the real optimum point, such local optimum point(s) may erroneously be determined to be an optimum point, thus posing a further problem.

On the other hand, in case of using a simulated annealing method or a genetic algorithm, in which random trial and error is used, the search time is protracted, even though it is then less likely that the locally optimum point is erroneously determined to be a real optimum point.

According to another method of the present invention, the problem of optimization to be solved is divided into a plurality of small problems, and an approximate solution is obtained by a direct method. With the use of the method for direct solution, herein termed a ‘direct method’, the aforementioned search may be dispensed with. With this direct method, the step S21, among the processing steps, shown in FIG. 6B, G is directly calculated from LΣ.

If attention is focused on the equation (15), U may be any unitary matrix. The variations, reproduced by the variation model, are not changed with selection of U. Thus, G that prescribes a variation model, yielding a certain result, is not unique. However, if actual variations are reproduced by a variation model, there is no practical impediment. It is therefore sufficient if one of equivalent Gs can be determined.

Thus, it is sufficient if, with U as a unitary matrix, the matrix G that approximately satisfies the following equation can be determined:

RG=LΣ (19)

Then, both sides of the equation (19) are made to be coincident with each other independently from column to column. That is, G is determined by partial optimization from column to column. Specifically, the first column of G is determined so that the first column of LΣ (first principal component vector) will be approximately coincident with the first column of RG.

The second column of G is then determined so that the second column of LΣ (second principal component vector) will be approximately coincident with the second column of RG.

The above is repeated up to the column of the number of orders as needed. This can be accomplished at a time if matrix calculations are used.

It is noted that the respective columns of G are determined so as to be approximately matched to the respective principal components of the variations.

The above-mentioned j'th column of G may be determined by applying the technique of linear regression analysis.

In the equation (19), the condition for determining the j'th column may be written as follows:

$$( \begin{matrix}{r}_{11} & {r}_{12} & … & {r}_{1 m} \\ {r}_{21} & {r}_{22} & ⋱ & ⋮ \\ ⋮ & ⋱ & ⋱ & ⋮ \\ {r}_{{n}^{′} 1} & {r}_{{n}^{′} 2} & … & {r}_{{n}^{′} m}\end{matrix} ) ( \begin{matrix}{g}_{1 j} \\ {g}_{2 j} \\ ⋮ \\ {g}_{mj}\end{matrix} ) = ( \begin{matrix}{λ}_{j}^{1 / 2} {l}_{1 j} \\ {λ}_{j}^{1 / 2} {l}_{2 j} \\ ⋮ \\ {λ}_{j}^{1 / 2} {l}_{{n}^{′} j}\end{matrix} ) \qquad ( 20 )$$

If, in the equation (20), the right side is thought of as being a list of actually occurring values of target variables, and the elements of R are thought of as being a list of actually occurring values of explanation variables, the equation is of the same form as the problem of linear regression analysis.

The method of determining g1j, g2j, . . . , gmj so that the sum of square errors obtained on summing the squares of the differences between the i'th rows of the left and right sides from i=1 to i=n′, is known as the formula of the least square method in the linear regression analysis.

Using this method, it is sufficient to give the j'th column vector of G by the following equation:

$$( \begin{matrix}{g}_{1 j} \\ {g}_{2 j} \\ ⋮ \\ {g}_{mj}\end{matrix} ) = {( {R}^{T} R )}^{- 1} {R}^{T} ( \begin{matrix}{λ}_{j}^{1 / 2} {l}_{1 j} \\ {λ}_{j}^{1 / 2} {l}_{2 j} \\ ⋮ \\ {λ}_{j}^{1 / 2} {l}_{{n}^{′} j}\end{matrix} ) \qquad ( 21 )$$

If the first to the M′th columns of the equation (21) are expressed in a matrix, the equation (11) is obtained.

In the foregoing, it is assumed that U of the equation (17) is a unitary matrix. However, U may also be any other unitary matrix. If U is an arbitrary unitary matrix, the variations expressed are not changed.

The equation (11) may thus be the following equation (22):

G=R⁺LΣU^{T} (22)

Although G thus obtained is changed, a variation model that is equivalent to the equation (11) may be obtained.

L₁Σ₁, obtained on singular value decomposition of the equation (18), yields a principal component vector reproduced by the variation model that is prescribed by the transformation matrix G.

The singular value decomposition of the equation (18) is desirably carried out at least once, even with the direct method, in order to confirm the error in fluctuation reproduction with G obtained, as shown in FIG. 6. See the step S22 of FIG. 6B.

FIGS. 7 and 8 show the results of reproduction of the principal components by the direct method of the present invention. As a model basis, BSIM4, commonly used in the related field, was used. As variable model parameters, ten parameters, namely L, W, TOX, VTH, VOFF, U0, VSAT, K1, NDEP and RDSW were selected (m=10). The number of cause parameters was also set to ten to carry out fitting (M=10).

In FIG. 7, shaded bar graphs, labeled ‘fitted’, indicate values of the standard deviation of the first to tenth principal components as fitted against measured data. It is noted that the values of the standard variation (square root of variance) shown are normalized to the value of the first principal component.

That is, the shaded bar graphs indicate first to tenth diagonal components of Σ1 obtained by singular value decomposition of the equation (18) carried out using G determined by the equation (11).

In FIG. 8, plots of circles, triangles, and squares, labeled ‘fitted’ indicate the components of the eigenvectors, matched to the first to third principal components as fitted to the measured data. That is, those plots indicate elements of the first to third column vectors of L obtained by the singular value decomposition of the equation (18) which was carried out using G determined by the equation (11).

On the other hand, the corresponding plots ‘measured’ indicate first to tenth diagonal components of Σ of the equation (10) and the elements of first to third column vectors of L.

It may be seen from FIGS. 7 and 8 that the method of the present invention allows determining a variation model which has optimally reproduced the measured manner of variations.

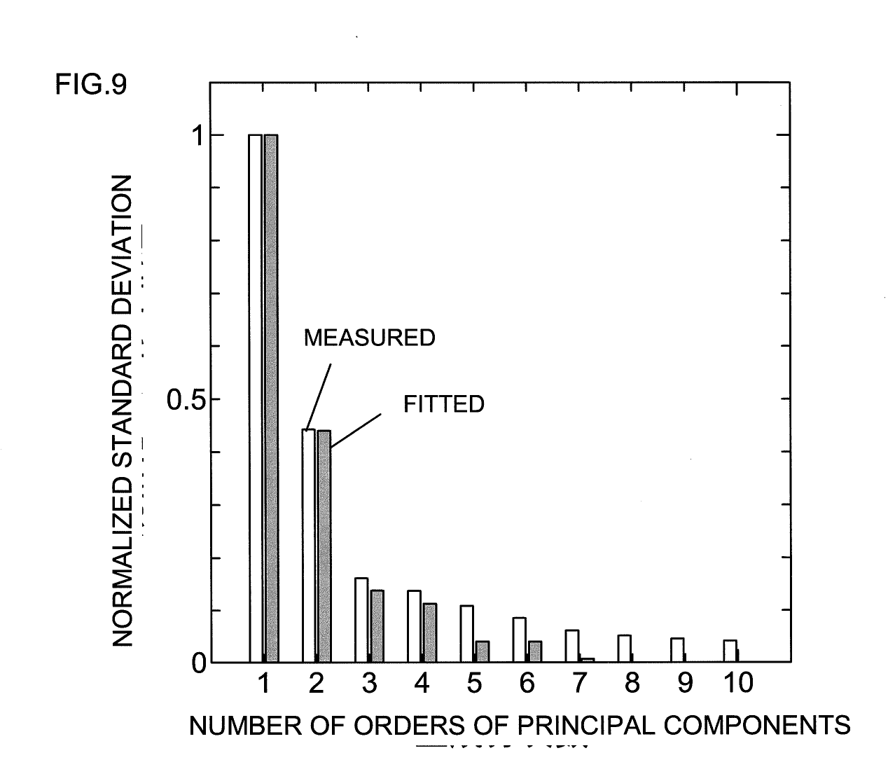

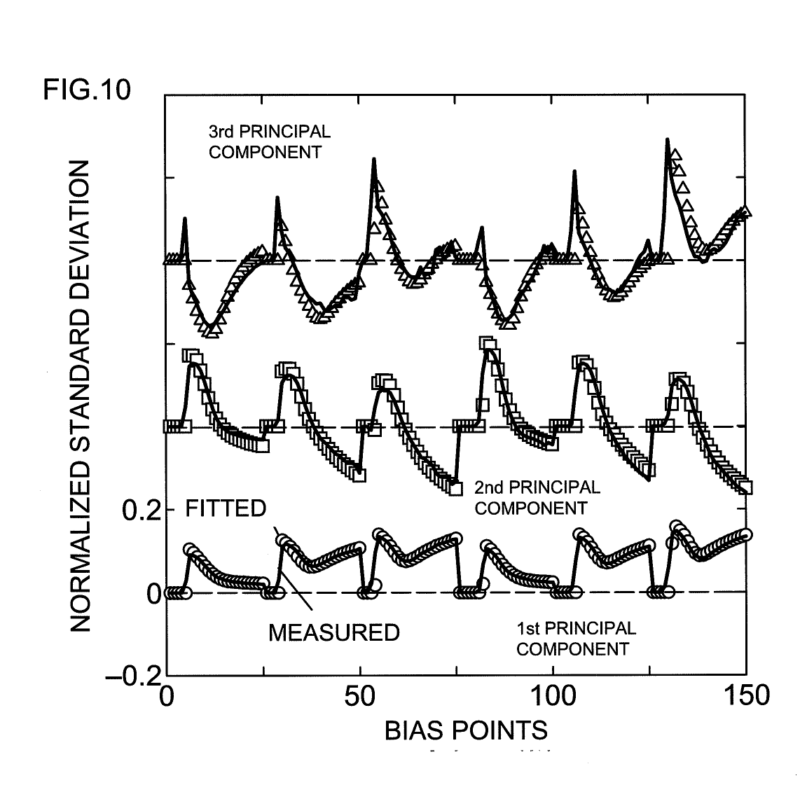

FIGS. 9 and 10 show the reproduced results of the principal components as obtained by the above-described search method.

In FIG. 9, shaded bar graphs, labeled ‘fitted’, represent the standard deviation (square root of the variance) of the first to tenth principal components as fitted to the measured data. The standard deviation has been normalized with the value of the first principal component.

That is, the first to tenth diagonal components of Σ1, which are optimum in minimizing the error, are shown. These diagonal components were obtained as a result of repeatedly carrying out the singular value decomposition of the equation (18) based on a trial-and-error method.

The plots of circles, triangles, and squares, labeled ‘fitted’ in FIG. 10, represent components of the eigenvector corresponding to the first to third principal components fitted to the measured data. That is, those plots represent optimum elements of the first to third column vectors of L that minimize the error. These elements have been obtained as a result of repeatedly carrying out the singular value decomposition of the equation (18) based on the trial-and-error method.

Meanwhile, the unshaded bar graphs, labeled ‘measured’ in FIG. 9, and solid-line plots, labeled ‘measured’ in FIG. 10, are the same as in FIGS. 7 and 8.

FIGS. 7 and 8 substantially coincide with each other, while FIGS. 9 and 10 substantially coincide with each other. In both of these pairs of figures, the optimal variation reproduction is achieved. However, the time of calculations in arriving at the results differs significantly.

In the present instance, the number of matrix elements to be determined by fitting is as many as 100. With the search method, if the number of unknown values is increased to this extent, the processing time is acutely increased. In this instance, a few hours were needed on a personal computer. Conversely, the time for calculations by the direct method is practically zero (a few seconds or less).

Meanwhile, if the number of unknown values is not greater than a few, there is no vital difference in the time of calculations. That is, search processing comes to a close within one minute.

To show the capability of reproduction of variations in the present invention, ten cause parameters were used in the present embodiment, and fitting was carried out up to a higher order principal component.

However, in practice, smaller numbers of the cause parameters may be used. In this case, only a number of the principal components up to the number of the cause parameters at most may be reproduced. However, since the principal components of the higher orders are sequentially smaller, no practical difficulties are encountered by restricting the number of the cause parameters.

The detailed investigation of the results of the direct method and the search method, shows that a delicate difference exists between the results of the two methods.

The evaluation function of the fitting error was
0.0971 for the search method and
0.1119 for the direct method.

That is, the error caused is slightly smaller with the search method than with the direct method, so that the fitting obtained with the search method is better.

With the direct method, an optimum solution is found for each principal component (partial optimum solution). A collection of the partial optimum solutions, thus obtained, generally differs from the real optimum solution for all of the principal components of interest (global optimum solution). With the search method, directly searching for the true optimum solution, it is possible to get to the real optimum solution. In sum, the solution by the direct method is sometimes inferior to that by the search method. However, the difference of the results is minor and practically negligible.

To further decrease an error, the transformation matrix G, obtained by the direct method, may be used as a start point, that is, as an initial trial value for G, and the search method may then be further applied to optimize the solution. By so doing, it is possible to reduce an error to as small a value as that obtained with the search method and in a shorter time than in case the search method is applied from the outset.

As a special case, there are cases where an inverse matrix exists for the response matrix R. In order for an inverse matrix to exist for the n′-row and m-column response column R, it is necessary that n′ is equal to m and R is a square matrix. If an inverse matrix for R exists, the pseudo-inverse matrix of R coincides with the inverse matrix of R, and R given by the equation (11) strictly satisfies the equation (19). Or, R given by the equation (22) strictly satisfies the equation (17).

As a principle, the direct method and the search method yield the same variation model. The direct method is therefore particularly superior to the search method in case an inverse matrix exists for R.

The method for determining the variation model according to the present invention is particularly superior in efficiency to the related art method in not extracting the parameters of the individual devices. Inter alia, the direct method is particularly high in efficiency in speeding up the operation of the fitting execution unit 300.

An integrated circuit usually employs devices of variegated dimensions. These devices usually exhibit variations which are variable from one device to another, so that it is a frequent occurrence that the devices need respective different variation models. Hence, to decide on a variation model matched to the wide variety of the devices, the fitting execution unit 300 desirably performs operations at as high a speed as possible.

The manner of expression of a given variation model is not unique, such that there are a variety of equivalent methods for expression. Which of these methods is to be used may properly be selected as indicated below by way of examples.

In the present description, only proper ones of a variety of methods for expression are selected for convenience in explanation without the intention of restricting the scope of the invention.

As already discussed, it is not necessary for the value of the variations of the cause parameters to be equal to 1. If the values of the standard deviation of the cause parameters x1, x2 and so forth are not set to 1, but are set to σ1, σ2 and so forth, and the transformation matrix is replaced by G′, as indicated by the following equation (23), it is possible to acquire an equivalent variation model.

$${G}^{′} = G ( \begin{matrix}1 / {σ}_{1} & 0 & … & 0 \\ 0 & 1 / {σ}_{2} & ⋱ & 0 \\ ⋮ & ⋱ & ⋱ & ⋮ \\ 0 & 0 & … & 1 / {σ}_{M}\end{matrix} ) \qquad ( 23 )$$

If conversely the transformation matrix G′ is replaced by G in accordance with the following equation (24), and the values of the standard deviation of the cause parameters are all normalized to 1, there is obtained an equivalent variation model. At this time, G is the normalized transformation matrix.

$$G = {G}^{′} ( \begin{matrix}{σ}_{1} & 0 & … & 0 \\ 0 & {σ}_{2} & ⋱ & 0 \\ ⋮ & ⋱ & ⋱ & ⋮ \\ 0 & 0 & … & {σ}_{M}\end{matrix} ) \qquad ( 24 )$$

It has been stated above in connection with the search method that the standard deviation of the cause parameter is assumed to be 1 and that search is to be conducted as the elements of the normalized transformation matrix G are varied. In carrying out the search method, it is also possible to vary not only the elements of the transformation matrix G, but also the values of the standard deviation σ1, σ2 and so forth as trial values. In this case, the normalized transformation matrix G of the equation (18) may be given by the equation (24).

It is noted that, in this case, the number of the unknown values to be determined is increased by M. However, this simply increases the number of methods for expression reciprocally equivalent to one another, while the number of the degrees of freedom of model expression is not increased. That is, the M excess degrees of freedom are redundant, such that, if search is carried out in this state, search is undesirably carried out in vain in the solution space of wide dimensions. It is therefore preferred to set proper constraints on the number of unknown numbers to be determined by search.

One desirable method is to set a constraint that the column vectors of G′ in the equation (24) are each of a length equal to 1 and orthogonal to one another. This does not decrease the number of the degrees of freedom of model expression, as will be apparent if reference is made to the following explanation on the equation (25).

It is seen from e.g. the equation (18) that, if G is multiplied from its right side by an arbitrary M-row and M-column unitary matrix, the result is an equivalent variation model. Thus, the equation (22) may be used in place of the equation (11), as already discussed.

In particular, if G is subjected to singular value decomposition, G may be transformed as indicated by the following equation (25):

$$G = {{G}^{′}}^{′} ( \begin{matrix}{s}_{1} & 0 & … & 0 \\ 0 & {s}_{2} & ⋱ & 0 \\ ⋮ & ⋱ & ⋱ & ⋮ \\ 0 & 0 & … & {s}_{M}\end{matrix} ) {U}_{2}^{T} , {GU}_{2} = {{G}^{′}}^{′} ( \begin{matrix}{s}_{1} & 0 & … & 0 \\ 0 & {s}_{2} & ⋱ & 0 \\ ⋮ & ⋱ & ⋱ & ⋮ \\ 0 & 0 & … & {s}_{M}\end{matrix} ) \qquad ( 25 )$$

where G″ is a matrix the respective columns of which are of a length equal to 1 and are orthogonal to one another (m-row and M-column matrix). U₂ is a unitary matrix (M-row and M-column matrix) and s1 to sM are singular values.

It is seen from the equation (25) that, if G″ is a transformation matrix and the values of the standard deviation of the cause parameters are s1, s2, . . . , sM, a variation model, equivalent to that in case G is the transformation matrix and the values of the cause parameters are equal to 1, is obtained. It is thus possible to select the transformation matrix so that the respective columns are of a length equal to 1 and are orthogonal to one another.

The search method is meritorious in that, in carrying out the search, arbitrary constraints may be set with ease on the elements of the matrix G or G′.

This may be accomplished by carrying out the search as the matrices G or G′ being tried and the values of the standard deviation of the cause parameters are selected at all times so that preset constraints will be met.

For example, if it is desired to impose the condition that model parameters are uncorrelated with one another, it suffices to execute the search as G′ is fixed as a unit matrix in the equation (24).

For example, it is assumed that the magnitude of variations of a given model parameter, such as a gate length L, has been known by advance measurement. In this case, it is sufficient to carry out the search as the condition that the standard deviation of the parameters is fixed at a known value is imposed.

Thus, the search method is particularly useful in case it is desired to obtain a solution as long as statistical properties of a model parameter satisfy a preset condition.

To select G for which statistical properties of a model parameter satisfy preset conditions, it is sufficient to do the following:

The statistical properties of a model parameter may be prescribed by the co-variance matrix Vₚ of the model parameter. Vₚ is subjected to principal component analysis, as in the equations (3) et seq., that is, Vₚ is subjected to eigen value decomposition to obtain the following equation:

$${V}_{p} {L}_{p} = {L}_{p} {Σ}_{p}^{2} , {Σ}_{p} = ( \begin{matrix}\sqrt{{μ}_{1}} & 0 & … & 0 \\ 0 & \sqrt{{μ}_{2}} & ⋱ & ⋮ \\ ⋮ & ⋱ & ⋱ & 0 \\ 0 & … & 0 & \sqrt{{μ}_{m}}\end{matrix} ) \qquad ( 26 )$$

where Lₚ is an m-row and m-column matrix, in which the eigenvectors of Vₚ are arrayed from the left side in the descending order of the eigenvalues, and μ1 to μm are eigenvalues of Vₚ.

The above is formally the same as the principal component analysis conducted on the characteristic value. Although the equation (26) is similar to the equation (10), there is a point of difference that here the target of the principal component analysis is not the characteristic value but the parameter.

If L_{P}Σ_{P}, thus obtained, is to be the normalized G, the co-variance matrix of the model parameter coincides with Vₚ.

If LΣ, obtained by eigenvalue decomposition of the co-variance matrix V of the characteristic value, is coincident with A=RG of the equation (12), as already discussed, the manner of variations of the characteristic values may be reproduced.

If it is considered that A and G are formally matched to each other and y and A p are matched to each other, and L_{P}Σ_{P}, obtained on eigenvalue decomposition of the covariance matrix of the parameters Vₚ, is G, the manner of variations of the model parameter may be reproduced.

Since the elements of Vₚ are all statistic quantities (variance and co-variance) of the parameters, the elements of Vₚ may easily be set in such a way that the parameters will satisfy preset statistical properties.

If L_{P}Σ_{P} is adopted as G, G is an m-row m-column matrix. Or, only M columns of larger magnitudes may be selected out of the columns of L_{P}Σ_{P} so that G is an m-row and M-column matrix. If part of columns of L_{P}Σ_{P} is omitted, the number of the cause parameters may be reduced, even though the fidelity in reproduction of the manner of variations of the parameters becomes inferior.

The co-variance matrix Vₚ of the device model parameter is subjected to eigenvalue decomposition to find Lₚ, and Σp, as elements of Vₚ are selected as appropriate as trial values, and as constraints are imposed on part of the elements of the co-variance matrix Vₚ of the device model parameters. These constraints may be exemplified by fixing the variance of the gate length L at a preset value or fixing the correlation coefficient between the gate length and the mobility at a preset value. By so doing, it is possible to select G for which the statistical property of the model parameter satisfy the preset condition.

If G, thus selected, is adopted as a trial value of G for the search method, such solution for which the statistical property of the model parameter satisfy the preset condition may be searched easily.

In applying the present invention, a model parameter may be expressed as the function of an arbitrary parameter in advance (parameter transformation) and the arbitrary parameter may then be deemed newly to be the parameter of the model.

For example, if the physical cause of the variations and the behavior of the model parameter thereto are known at the outset, the parameter that describes the cause may be used as the aforementioned arbitrary parameter.

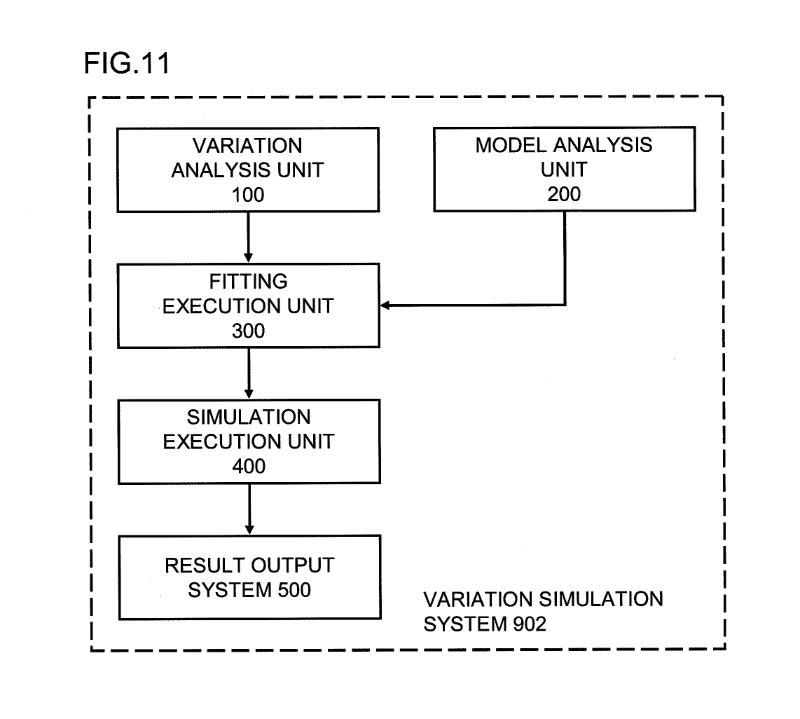

Referring to FIG. 11, a variation simulation system 902 according to a second exemplary embodiment of the present invention includes a variation analysis unit 100, a model analysis unit 200, a fitting execution unit 300, a simulation execution unit 400 and a result output unit 500.

The simulation execution unit 400 executes circuit simulation, as appropriate, based on a variation model. A typical method of using circuit simulation is a Monte-Carlo experiment. That is, circuit characteristics are iteratively calculated, as the cause parameter is statistically varied with a preset distribution function, using random numbers, to investigate into how the circuit characteristics are varied. If there is no detailed designation of the distribution function, the normal distribution, having a preset value of the standard deviation, may reasonably be used as the aforementioned distribution function.

More specifically, the following steps are carried out in order:

### Step 1:

Using random numbers as cause parameters, a set of cause parameters x1, x2, . . . , xM, randomly deviated from the center value, are determined.

### Step S2:

Model parameters p1, p2, . . . , pm, deviated from the above set of the cause parameters, are determined, using the equations (8) or (9).

### Step S3:

Using the so determined deviated device model, circuit simulation is carried out, as appropriate, to investigate into circuit characteristics.

With the above as one set of trial operations, a preset number of sets of the trial operations are carried out. From the results of the trial operations, it can be seen how circuit characteristics are varied.

To execute the above-mentioned circuit simulation, the information on
device models, preferably a center model; and
the conditions for carrying out simulation (the information on the arrangement of a circuit including the devices and the bias condition to be simulated)
   is further needed in addition to the variation model.

As for the conditions for carrying out simulation, it is sufficient if the simulation execution unit 400 is able to acquire them as appropriate, using the methods adopted in general circuit simulation, in a manner not shown.

The cause parameters are preferably selected so as to be matched to the cause of the variations of truly physical variations. The object of the present invention may be fulfilled if the variations observed can be reproduced by simulation. The present invention remains valid even if the cause parameter in such case is merely a fitting parameter having no physical meaning. However, the cause parameter is preferably selected so as to have the physical meaning since then it assists in understanding the physical meaning of the fluctuation phenomenon.

The present invention is featured by the fact that no particular constraint is imposed on a model basis for simulation that is used. The present invention determines a variation model by exploiting the response of the device model to changes in the parameters without directly using the detailed inner information of the model basis. Thus, with the present invention, the model basis can be interchanged freely.

The user may properly select pre-existing model basis, for example, those in popular use as de-facto standard, for combination with the present invention. The result is that, since there is no necessity of changing pre-existing designing environments or resources, the environment for execution of variation simulation may be constructed at a reduced cost. To take advantage of this feature, the variation simulation system of the present invention may be constructed so that the model basis used may arbitrarily be selected by the user.

The foregoing description has been made on the basis of an example of application to circuit simulation inclusive of electronic devices, in particular an example of application to current to voltage characteristics of MOSFETs. However, the technique that forms the basis of the present invention is not limited by particular sorts of devices applied or characteristics thereof and may be applied to any device characteristics that may be expressed by a model.

Thus, the quantities that express device characteristics may be any of the current, voltage, capacitance, inductance or resistance, or quantities derived therefrom. For example, the quantities expressing device characteristics may be mutual conductance, obtained on differentiating the current at the drain terminal by the voltage at the gate terminal, or an output resistance obtained on differentiating the voltage at the drain terminal with the current at the drain terminal. In the case of a bipolar transistor, those quantities may also be an emitter grounded current amplification ratio, obtained on dividing the current at the collector terminal with the current at the base terminal, or a base grounded current amplification ratio, obtained on dividing the current at the collector terminal with the current at the emitter terminal.

The quantities that express device characteristics may also be complex voltage or complex current having the information on amplitude and phase of an a.c. signal. Those quantities may also be other quantities derived therefrom, for example, complex admittance, complex impedance, S-parameter, Y-parameter or h-parameter.

The quantities that express device characteristics may also be optical quantities, such as light intensity, light phase, refractive index, transmittance or reflectance, or other quantities, derived therefrom, in an optical device, such as light emitting diode or semiconductor laser.

The quantities that express device characteristics may also be mechanical quantities in mechanical devices, such as displacement, bend, movement speed or the force of friction, or other quantities derived therefrom.

The devices may be enumerated by a variety of semiconductor devices, such as MISFETs, MESFETs, JFETs, bipolar transistors, a variety of diodes, such as light emitting diodes, semiconductor laser or solar cells, thyristors or CCDs, in addition to MOSFETs. Those devices may also be any devices, other than the semiconductor devices, such as liquid crystal display devices, plasma display devices, field emission type display devices, organic light emitting display devices, vacuum tube amplifiers, vacuum tube light emitting devices or a variety of devices for MEMS, such as actuators or sensors.

Circuit simulation models the characteristics of electronic devices, as a physical phenomenon, by a mathematical equation. However, as apparent from the foregoing description, in case an arbitrary phenomenon is to be modeled by a mathematical equation, and variations of the phenomenon are to be reproduced by a model, the present invention may, in similar manner, be applied as in the case of electronic devices.

The technique of the present invention resides not in extracting parameters from each of N devices followed by searching into the statistical properties of the parameters, but rather in initially searching into the statistical properties of the characteristic values of the N devices and in subsequently determining the manner of variations of the device model parameters in such a way as to reproduce the characteristic values of the N devices. In determining the manner of variations of the parameters of the device model, the technique of the present invention exploits information on what the response is to the device model parameters.

In this manner, the manner of variations of the parameters may be determined by fitting only once, without the necessity of carrying out parameter extraction operations N times. This enables efficient determination of a model for expressing the variations (variation model) for carrying out circuit simulation in such a way as to take account of variations in detail.

The present invention may be applied to designing of circuits employing electronic devices and, in particular, to designing of integrated circuits.

The present invention is not limited to the above-described exemplary embodiment and may be applied to the case of reproducing variations of various phenomena by models in a similar manner to the above-described case of electronic devices.

Although the present invention has so far been described with reference to preferred embodiments, the present invention is not to be restricted to the embodiments. It is to be appreciated that those skilled in the art can change or modify the embodiments without departing from the spirit and the scope of the present invention.

What is claimed:

1. A variation simulation system, wherein the system determines the manner of variations of a preset parameter, based on response information of a characteristic value simulated by a model, to the preset parameter, so that a statistical property of the characteristic value will be reproduced by the model, the characteristic value reflecting a physical phenomenon, the physical phenomenon being simulated by the model.

2. A variation simulation system comprising:
a variation analysis unit that extracts a statistical property of a characteristic value which reflects a physical phenomenon;
a model analysis unit that acquires response information of the characteristic value simulated by a model which simulates the physical phenomenon to a preset parameter; and
a fitting execution unit that determines the manner of variations of the preset parameter, based on the response information, so that the statistical property will be reproduced by the model.

3. An apparatus for determining a variation model, comprising:
a variation analysis unit that extracts a statistical property of a characteristic value which reflects a physical phenomenon;
a model analysis unit that acquires response information of the characteristic value simulated by a model which simulates the physical phenomenon to a preset parameter; and
a fitting execution unit that determines the manner of variations of the preset parameter, based on the response information, so that the statistical property will be reproduced by the model.

4. A method for determining a variation model, using a computer system, the method comprising:
extracting a statistical property of a characteristic value which reflects a physical phenomenon;
acquiring response information of the characteristic value simulated by a model which simulates the physical phenomenon to a preset parameter; and
determining the manner of variations of the preset parameter, based on the response information, so that the statistical property will be reproduced by the model.

5. A program causing a computer to execute:
a processing of extracting a statistical property of a characteristic value which reflects a physical phenomenon;
a processing of acquiring response information of the characteristic value simulated by a model which simulates the physical phenomenon to a preset parameter; and
a processing of determining the manner of variations of the preset parameter, based on the response information, so that the statistical property will be reproduced by the model.

6. The apparatus according to claim 3, wherein the variation analysis unit extracts the statistical property of the characteristic value which reflects the physical phenomenon using principal component analysis.

7. The apparatus according to claim 3, wherein the model analysis unit determines the response information by analyzing the response of the simulated characteristic value to the preset parameter.

8. The apparatus according to claim 3, wherein the model analysis unit determines the response information by calculating the deviation of the simulated characteristic value caused by a deviation of the preset parameter.

9. The apparatus according to claim 3, wherein the fitting execution unit determines the manner of variations of the preset parameter, so that the result of singular value decomposition of a product of a response matrix and a transformation matrix, and the result of principal component analysis of the characteristic value are made to coincide or approximately coincide with each other.

10. The apparatus according to claim 3, further comprising
a simulation execution unit that executes simulation, based on the manner of variations of the preset parameter determined.

11. The apparatus according to claim 3, wherein both the characteristic value and the simulated characteristic value are subjected to the same transformation.

12. The apparatus according to claim 3, wherein the fitting execution unit determines the manner of variations of the preset parameter by a direct method.

13. The apparatus according to claim 3, wherein the means for determining the fitting execution unit determines coefficient or a transformation matrix which correlates a cause parameter with a parameter included in the model, by performing regression analysis to the result of the principal component analysis.

14. The apparatus according to claim 3, wherein a pseudo inverse matrix of a response matrix, a matrix comprising principal component vectors, and an arbitrary unitary matrix are multiplied to determine a transformation matrix.

15. The apparatus according to claim 3, wherein an inverse matrix of a response matrix, a matrix comprising principal component vectors and an arbitrary unitary matrix are multiplied to determine a transformation matrix.

16. The apparatus according to claim 3, wherein a pseudo inverse matrix of a response matrix and a matrix comprising principal component vectors are multiplied by each other to determine a transformation matrix.

17. The apparatus according to claim 3, wherein an inverse matrix of a response matrix and a matrix comprising principal component vectors are multiplied by each other to determine a transformation matrix.

18. The apparatus according to claim 12, wherein the fitting execution unit determines the manner of variations of the preset parameter by further carrying out a search method, with the result of the direct method as an initial value.

19. The apparatus according to claim 3, wherein the fitting execution unit determines the manner of variations of the preset parameter, so that at least a part of the statistical property of the preset parameter will satisfy a preset condition.

20. The apparatus according to claim 3, wherein a preset constraint condition is imposed on a trial value of a transformation matrix.

21. The apparatus according to claim 3, wherein a preset constraint condition is imposed on a trial value of a transformation matrix, so that at least a part of the statistical property of the parameter will satisfy a preset condition.

22. The apparatus according to claim 3, wherein a trial value of a transformation matrix is determined by principal component analysis of the parameter.

23. The apparatus according to claim 3, wherein parameter transformation is made in which a model parameter is deemed to be a function of another parameter.

24. The apparatus according to claim 3, wherein the number of cause parameters is set so as to be smaller than the number of parameters of a model to be varied.

25. The apparatus according to claim 9, wherein the transformation matrix is an m-row and M-column matrix that transforms cause parameter of an M-dimensional vector to a model parameter of an m-dimensional vector.

26. The apparatus for according to claim 3, wherein in determining a variation model by determining a matrix G, in which a relationship RG=LΣU^{T}, U being a unitary matrix and T indicating transpose, at least approximately holds,
where R is an n′-row and m-column response matrix;
V is an n′-row and n′-column co-variance matrix of a characteristic value;
G is an m-row and M-column transformation matrix that transforms an M-dimensional vector of cause parameter, normalized to a standard deviation equal to 1, to an m-dimensional vector of model parameter;
L is an n′-row and M-column matrix having arrayed eigenvectors of M columns of V from the first column in the descending order of the eigenvalues;
Σ is an M-row and M-column diagonal matrix having arrayed square roots √λ₁, √λ₂, . . . √λ_{M} of eigenvalues, λ₁, λ₂, . . . λ_{M} of V as diagonal elements; and
an equation VL=LΣ² holds;
G is solved by a direct method in which respective columns of G are determined so that respective columns of RG approximately coincide with respective columns of LΣU^{T}, where U is an arbitrary unitary matrix.

27. The apparatus according to claim 26, wherein the transformation matrix G is found as
G=(R^{T}R)⁻¹R^{T}LΣ
by linear regression analysis.

28. The apparatus according to claim 26, wherein the transformation matrix G is found as
G=(R^{T}R)⁻¹R^{T}LΣU^{T}
by linear regression analysis, where U is an arbitrary unitary matrix.

29. The apparatus according to claim 26, wherein the normalized transformation matrix G, obtained by the direct method, is subjected to singular value decomposition to obtain RG=L₁Σ₁U₁^{T}, where L₁ is an n′-row and M-column orthogonal matrix, with each column being of a length equal to 1, Σ₁ is an M-row and M-column diagonal matrix and U₁ is an M-row and M-column unitary matrix.

30. The apparatus according to claim 26, wherein G is found by a search method, in which
a normalized transformation matrix G, obtained by the direct method, is used as a trial value;
RG is subjected to singular value decomposition, where G is the trial value of G;
the degree of coincidence between the principal component vectors LΣ of actual variations and the principal component vectors L₁Σ₁ of reproduced variations is checked; if a preset coincidence condition is met, the trial value of G is adopted as G being found; in case of non-coincidence, another trial value of G is selected and re-tried.

31. The apparatus according to claim 3, wherein, in solving an equation RG=LΣU^{T}, U being a unitary matrix and T meaning transpose, where
R is an n′-row and m-column response matrix;
V is an n′-row and n′-column co-variance matrix of a characteristic value;
G is an m-row and M-column transformation matrix that transforms an M-dimensional vector of cause parameter, normalized to a standard deviation equal to 1, to an m-dimensional vector of model parameter;
L is an n′-row and M-column matrix having arrayed eigenvectors of M columns of V from the first column in the descending order of the eigenvalues;
Σ is an M-row and M-column diagonal matrix having arrayed square roots √λ₁, √λ₂, . . . √λ_{M} of eigenvalues λ₁, λ₂, . . . λ_{M} of V as diagonal elements; and
an equation VL=LΣ² holds;
a trial value for G is selected,
a product of R and G is subjected to singular value decomposition to obtain RG=L₁Σ₁U₁^{T}, where L₁ is an n′-row and M-column orthogonal matrix, with each column of a length equal to 1, Σ₁ is an M-row and M-column diagonal matrix and U₁ is an M-row and M-column unitary matrix,
the degree of coincidence between the principal component vectors of actual variations LΣ and those of reproduced variations L₁Σ₁ is checked, and
in case of a preset coincidence condition being met, the trial value of the matrix G is adopted as G being found, in case of non-coincidence, another trial value of G being selected and re-tried.

32. The apparatus according to claim 3, wherein the standard deviation of a cause parameter is normalized to 1 to carry out the processing.

33. The apparatus according to claim 3, wherein, G′ that satisfies the relationship G=G′S, where G is a normalized transformation matrix, S′ is an M-row and M-column diagonal matrix having the values of standard deviation σ₁, σ₂, . . . σ_{M} of the cause parameters arrayed as the diagonal elements, is used as a transformation matrix.

34. The apparatus according to claim 3, wherein a normalized transformation matrix G is subjected to singular value decomposition to obtain G=G″SU₂^{T}, where G″ is an m-row and M-column orthogonal matrix with each column being of a length equal to 1, U₂ is an M-row and M-column unitary matrix and S is an M-row and M-column diagonal matrix having singular values s₁, s₂, . . . , s_{M} arrayed as the diagonal elements, and wherein
G″ is selected as a transformation matrix so that respective columns of the transformation matrix are of a length equal to 1 and are orthogonal to each other.

35. The apparatus according to claim 31, wherein a co-variance matrix Vₚ of a model parameter is subjected to singular value decomposition to obtain V_{P}L_{P}=L_{P}Σ_{P}², where Lₚ is an m-row and m-column orthogonal matrix having eigenvectors of Vₚ arrayed from the first column in the descending order of the eigenvalues and Σ_{P} is an m-row and m-column diagonal matrix having square roots √μ₁, √μ₂, . . . √μₘ of eigenvalues μ₁, μ₂, . . . μₘ of Vₚ arrayed as diagonal elements, and wherein
a matrix obtained on selecting part of columns of L_{P}Σ_{P} or L_{P}Σ_{P} with larger eigenvalues is used as a trial value of a normalized transformation matrix G.

36. The method according to claim 4, wherein the first step determines the statistical property by principal component analysis.

37. The method according to claim 4, wherein the second step determines the response information by calculating the deviation of the simulated characteristic value that is caused by a deviation of the preset parameter.

38. The method according to claim 4, wherein the third step determines the manner of variations of the preset parameter, so that the result of singular value decomposition of a product of a response matrix and a transformation matrix is made to be coincident or approximately coincident with the result of principal component analysis of the characteristic value.

39. The method according to claim 4, wherein the characteristic value and the simulated characteristic value are subjected to the same transformation.

40. The method according to claim 4, wherein the manner of variations of the preset parameter is determined by a direct method.

41. The method according to claim 4, wherein a coefficient or a transformation matrix that correlates a cause parameter with a parameter included in the model by regression analysis to the result of the principal component analysis.

42. The method according to claim 4, wherein a pseudo inverse matrix of a response matrix, a matrix including principal component vectors and an arbitrary unitary matrix are multiplied to determine a transformation matrix that transforms the cause parameter to a model parameter.

43. The method according to claim 4, wherein an inverse matrix of a response matrix, a matrix including principal component vectors and an arbitrary unitary matrix are multiplied to determine a transformation matrix that transforms the cause parameter to a model parameter.

44. The method according to claim 4, wherein a pseudo inverse matrix of a response matrix and a matrix including principal component vectors are multiplied by each other to determine a transformation matrix that transforms the cause parameter to a model parameter.

45. The method according to claim 4, wherein an inverse matrix of a response matrix and a matrix including principal component vectors are multiplied by each other to determine a transformation matrix that transforms the cause parameter to a model parameter.

46. The method according to claim 40, wherein a search method is further carried out with the result of the direct method as an initial value.

47. The method according to claim 4, wherein the manner of variations of the preset parameter is determined so that at least a part of the statistical property of the parameters will satisfy a preset condition.

48. The method according to claim 4, wherein a preset constraint condition is imposed on a trial value of a transformation matrix.

49. The method according to claim 4, wherein a preset constraint condition is imposed on a trial value of a transformation matrix so that at least a part of the statistical property of the parameter will satisfy a preset condition.

50. The method according to claim 4, wherein a trial value of the transformation matrix is determined by principal component analysis of the parameter.

51. The method according to claim 4, wherein parameter transformation is made in which a model parameter is deemed to be a function of another parameter.

52. The method according to claim 4, wherein the number of the cause parameters is set so as to be smaller than the number of the model parameters to be changed.

53. The program according to claim 5, wherein the first processing determines the statistical property by principal component analysis.

54. The program according to claim 5, wherein the second processing determines the response information by calculating the deviation of the simulated characteristic value caused by a deviation of the preset parameter.

55. The program according to claim 5, wherein the third processing determines the manner of variations of the preset parameter by making the result of singular value decomposition of the product of the response matrix and the transformation matrix coincident or approximately coincident with the result of principal component analysis of the characteristic value.

56. The program according to claim 5, wherein simulation is carried out on the basis of the manner of variations of the preset parameter determined.

57. The program according to claim 5, wherein the characteristic value and the simulated characteristic value are subjected to the same transformation.

58. The program according to claim 5, wherein the manner of variations of the preset parameter is determined by a direct method.

59. The program according to claim 5, wherein a coefficient or a transformation matrix that correlates the cause parameter with a parameter included in the model is determined by regression analysis to the result of the principal component analysis.

60. The program according to claim 5, wherein a pseudo inverse matrix of a response matrix, a matrix including principal component vectors and an arbitrary unitary matrix are multiplied to determine a transformation matrix that transforms a cause parameter to a model parameter.

61. The program according to claim 5, wherein an inverse matrix of a response matrix, a matrix including principal component vectors and an arbitrary unitary matrix are multiplied to determine a transformation matrix that transforms a cause parameter to a model parameter.

62. The program according to claim 5, wherein a pseudo inverse matrix of a response matrix and a matrix including principal component vectors are multiplied by each other to determine a transformation matrix that transforms a cause parameter to a model parameter.

63. The program according to claim 5, wherein an inverse matrix of the response matrix and a matrix including principal component vectors are multiplied with each other to determine a transformation matrix that transforms a cause parameter to a model parameter.

64. The program according to claim 58, wherein a search method is further carried out with the results of the direct method as an initial value.

65. The program according to claim 5, wherein the manner of variations of the preset parameter is determined so that at least part of the statistical property of the parameter will satisfy the preset condition.

66. The program according to claim 5, wherein a preset constraint condition is imposed on a trial value of a transformation matrix that transforms a cause parameter to a model parameter.

67. The program according to claim 5, wherein a preset constraint condition is imposed on a trial value of a transformation matrix so that at least a part of the statistical property of the parameter will satisfy a preset condition.

68. The program according to claim 5, wherein a trial value of the transformation matrix is determined by principal component analysis of the parameter.

69. The program according to claim 5, wherein parameter transformation is made in which a model parameter is deemed to be a function of another parameter.

70. The program according to claim 5, wherein the number of the cause parameters is set so as to be smaller than the number of the model parameter to be changed.
